(19) United States
(12) Patent Application Publication
(10) Pub. No.: US 2026/0214165 A1
(43) Pub. Date: Jul. 23, 2026

(54) User Interfaces for Identifying Communication Sessions Requiring Human Supervision

(71) Applicant: ClonesOps.ai, LLC, Fort Lauderdale, FL (US)

(72) Inventors: David Ernest Bell, Fort Lauderdale, FL (US); Roger Boza, Miami, FL (US); Sasa Jovicic, Parkland, FL (US); Cesar Reyes, Miami, FL (US); Nagarajan Prabakar, Miami, FL (US)

(21) Appl. No.: 19/454,332

(22) Filed: Jan. 20, 2026

Related U.S. Application Data
(60) Provisional application No. 63/747,665, filed on Jan. 21, 2025.
(60) Provisional application No. 63/779,890, filed on Mar. 28, 2025.

(51) Int. Cl. H04M 3/51

(52) U.S. Cl. CPC H04M 3/5175; H04M 3/5166; H04M 3/5183; H04M 2201/40; H04M 2201/42

(57) ABSTRACT

User interfaces for identifying communication sessions requiring human supervision are disclosed. According to an aspect, a system includes a communication session manager configured to define a supervising human agent. The communication session manager is configured to identify a virtual entity communication sessions assigned to the supervising human agent, thus defining a plurality of monitored virtual entity communication sessions. Further, the communication session manager is configured to render a user interface that presents the monitored virtual entity communication sessions. The communication session manager is also configured to receive selection, by the supervising human agent, of one of the plurality of monitored virtual entity communication sessions, thus defining a selected virtual entity communication session. Further, the communication session manager is configured to involve the supervising human agent in the selected virtual entity communication session.

### CROSS-REFERENCE TO RELATED APPLICATIONS

This application claims priority to U.S. Provisional Patent Application No. 63/747,665, filed Jan. 21, 2025, and titled “Interactive Dashboard with TakeOver and BadAsk System and Method”; and U.S. Provisional Patent Application No. 63/779,890, filed Mar. 28, 2025, and titled “AI System and Method”; the contents of which are incorporated herein by reference in their entireties.

### BACKGROUND

With the increasing adoption of Artificial Intelligence (AI)-driven customer service systems, many organizations are leveraging automated agents to handle routine inquiries, manage high call volumes, and improve operational efficiency. These systems offer scalability and cost savings, but they are not yet flawless when dealing with complex customer interactions. Challenges such as nuanced questions, emotional customer responses, or ambiguous scenarios often necessitate human intervention to ensure customer satisfaction and issue resolution.

To address these limitations, hybrid systems combining AI and human collaboration are emerging as the optimal solution. A key component of these systems is the ability for human representatives to seamlessly take over live calls when needed. This functionality not only bridges the gap between AI and human understanding but also ensures a smooth and professional experience for customers. Such systems are particularly vital in industries where precision, empathy, and contextual understanding are paramount, such as logistics, healthcare, financial services, publishing agencies, and debt collection.

Industries, such as logistics, benefit greatly from real-time issue resolution and effective communication, especially when managing supply chains and meeting tight delivery expectations. Similarly, sectors such as healthcare demand empathetic and accurate support for sensitive interactions, while financial services require precision and trustworthiness. Publishing agencies and debt collection also face unique challenges where combining AI efficiency with human intervention enhances customer experience and operational success. By integrating human representatives into AI-managed interactions, businesses across these industries can effectively address complex scenarios that automated systems alone may struggle to resolve.

### SUMMARY OF THE DISCLOSURE

The presently disclosed subject matter relates to user interfaces for identifying communication sessions requiring human supervision. According to an aspect, a system includes a communication session manager configured to define a supervising human agent. The communication session manager is configured to identify a plurality of virtual entity communication sessions assigned to the supervising human agent, thus defining a plurality of monitored virtual entity communication sessions. Further, the communication session manager is configured to render a user interface that presents the plurality of monitored virtual entity communication sessions. The communication session manager is also configured to receive selection, by the supervising human agent, of one of the plurality of monitored virtual entity communication sessions, thus defining a selected virtual entity communication session. Further, the communication session manager is configured to involve the supervising human agent in the selected virtual entity communication session.

### BRIEF DESCRIPTION OF DRAWINGS

Having thus described the presently disclosed subject matter in general terms, reference will now be made to the accompanying Drawings, which are not necessarily drawn to scale, and wherein:

FIG. 1 is a block of system for management of virtual entity communication sessions by a user (or manager) in accordance with embodiments of the present disclosure;

FIG. 2 is a block of virtual dispatching system for monitoring shipments available for dispatch and for engagement of shipment carriers via virtual entities in accordance with embodiments of the present disclosure;

FIG. 3 is a diagram depicting a voice authentication pipeline using convolutional autoencoders in accordance with embodiments of the present disclosure; and

FIG. 4 is a diagram depicting spectrogram error for voice authentication in accordance with embodiments of the present disclosure.

### DETAILED DESCRIPTION OF THE DISCLOSURE

The following detailed description is made with reference to the figures. Exemplary embodiments are described to illustrate the disclosure, not to limit its scope, which is defined by the claims. Those of ordinary skill in the art will recognize a number of equivalent variations in the description that follows.

Articles “a” and “an” are used herein to refer to one or to more than one (i.e. at least one) of the grammatical object of the article. By way of example, “an element” means at least one element and can include more than one element.

“About” is used to provide flexibility to a numerical endpoint by providing that a given value may be “slightly above” or “slightly below” the endpoint without affecting the desired result.

The use herein of the terms “including,” “comprising,” or “having,” and variations thereof is meant to encompass the elements listed thereafter and equivalents thereof as well as additional elements. Embodiments recited as “including,” “comprising,” or “having” certain elements are also contemplated as “consisting essentially of” and “consisting” of those certain elements.

Unless otherwise defined, all technical terms used herein have the same meaning as commonly understood by one of ordinary skill in the art to which this disclosure belongs.

In accordance with embodiments, a hybrid AI-human system is disclosed that provides a robust framework for managing customer interactions efficiently and effectively. Through features, such as live call monitoring and takeover functionality, representatives can intervene seamlessly in AI-handled calls, ensuring that complex or sensitive issues are addressed promptly. The system includes an interactive dashboard that supports real-time transcription, sentiment analysis, and proactive escalation, empowering representatives to prioritize and resolve challenges while maintaining an optimal customer experience.

In embodiments, a system as disclosed herein provides a user-friendly AI-powered virtual assistant that enhances user engagement by facilitating onboarding, answering questions, and providing real-time analytics insights. With voice interaction capabilities and integration with the dashboard, this virtual assistant can provide a hands-free, intuitive approach for users to navigate platform features and query data, such as average load booking prices or performance metrics. The system can also support scenario simulations, making data-driven decision-making accessible to non-technical users. Additionally, the virtual assistant can streamline the user experience by assisting with website navigation, booking demos, and showcasing the platform's advanced AI capabilities through interactive demonstrations.

Systems disclosed herein can integrate seamlessly to create a unified platform that supports diverse business needs. From proactive escalation of flagged calls to interactive insights provided by the virtual assistant, the platform ensures a user-friendly, efficient, and data-driven environment. This combination of advanced AI, human collaboration, and interactive tools can elevate customer service quality while enabling businesses to adapt dynamically to operational demands.

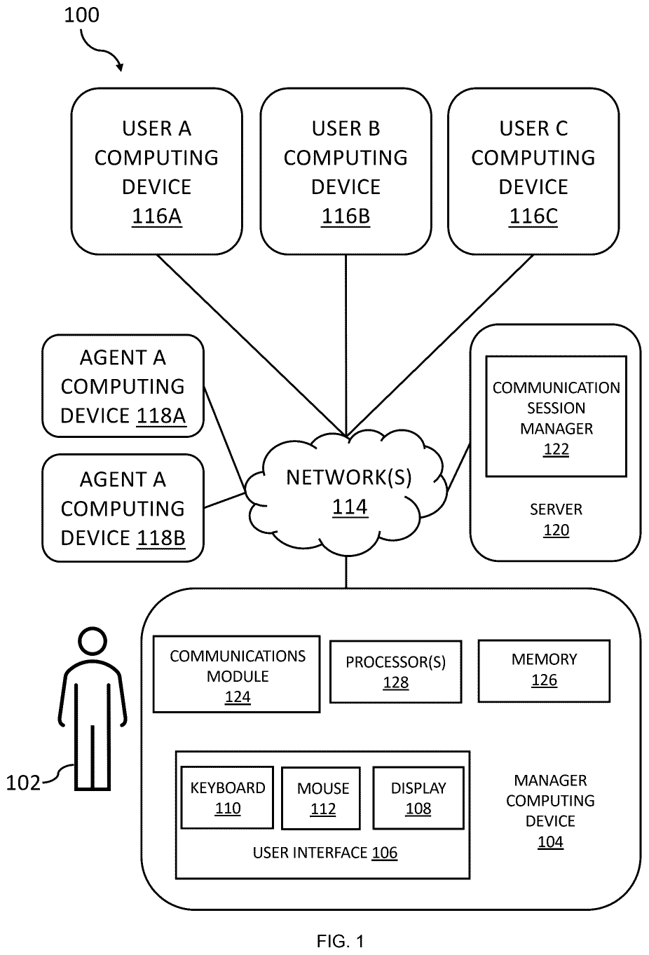

FIG. 1 illustrates a block of system 100 for management of virtual entity communication sessions by a user (or manager) 102 in accordance with embodiments of the present disclosure. Referring to FIG. 1, the system 100 includes a computing device 104 operated by the user 102. The computing device 104 may include a user interface 106 for interaction with the user 102. For example, the user interface 106 may include a display 108, a keyboard 110, and a mouse 112. The display 108 may be controlled to display prompts, graphics, text, and the like to a user for interaction in accordance with embodiments of the present disclosure.

The system 100 may utilize a telephony infrastructure, application servers, and databases (not shown for simplification of illustration) for receiving incoming calls, classifying incoming calls, and routing them to appropriate automated or human agents. Further, the system 100 may suitable record metrics for monitoring and optimization. The system 100 may also handle call signaling, apply routing logic based on rules and customer data, and coordinate voice paths and screen pops to agents.

The system 100 may include one or more telephony gateways or intelligent call management platforms that receive incoming calls from public or IP-based networks 114. Application servers hosting call routing, rules, IVR, and customer interaction logic may be suitably implemented by hardware, software, and/or firmware. For example, the servers may include one or more processors and associate memory for implementing these functionalities. Databases may store customer profiles, historical call metrics, and service/network status information used to guide call handling decisions. These components of the system 100 may interoperate over the network(s) 114 so that signaling and customer context can be exchanged between telephony equipment and applications.

When a customer initiates a call (for example to an 800-number), signaling for the call is delivered over a connection into the call center or customer premises system. The system receives a call request that typically includes a called number or destination identifier used to determine the service or queue; and caller-related information such as ANI/CLI or an explicit customer identifier that can be used to look up customer records. The system may distinguish among multiple intended recipients or service categories based on the destination identifier or dialed number and associate the incoming call with an internal call object in memory.

Before routing to a human representative, the call may be processed by an automated system such as an IVR or other computer-controlled interaction mechanism. In an example, voice prompts may be played and user input collected via DTMF, speech recognition, or other input mechanisms to identify the reason for the call. Further, customer and network/service status databases may be queried to obtain attributes such as account status, recent trouble tickets, or outage conditions. Rule engines may be applied to combine customer attributes, call history, and service conditions into a category, priority, or market segment for the call. The classification results may be stored in association with the call record and used downstream in routing decisions.

In the example of FIG. 1, multiple user computing devices 116A, 116B, and 116C are shown in FIG. 1 and may be operated by users A, B, and C, respectively. The system 100 may receive incoming calls from computing devices 116A, 116B, and 116C and route the incoming call to a computing device (e.g., agent computing device 118A or agent computing device 118B) of a call management agent (e.g., Agent A or Agent B). It is noted that although only two (2) agent computing devices 118A and 118B are shown, the system 100 may include any suitable number of agent computing devices. Similarly, only three (3) user computing devices 116A, 116B, and 116C are shown, but it should be understood that the system 100 may receive and manage any suitable number of calls from any suitable number of user computing devices.

When a call is delivered to an agent computing device (e.g., computing device 118A or 118B), the system 100 can coordinate both the media path and associated data. Typical technical features include establishing a voice path between the customer endpoint and an agent endpoint through the telephony switch or media gateway. Further, a screen pop may be delivered to the agent's computing device that includes customer identity, interaction history, classification, and any IVR-collected data pulled from databases. Stored information, such as agent skill utilization, response times, and outcome codes, may be stored after call completion to refine future routing and forecasting logic.

A server 120 of the system 100 may include a communication session manager 122 configured to define a supervising human agent for communications sessions, such as calls being handled for computing devices 116A, 116B, and 116C. As an example, the system 100 may be handling call sessions with computing devices 116A, 116B, and 116C. These call sessions may be handled by agents at computing devices 118A and 118B, and/or non-human agents (or virtual agent) of the system 100. Call sessions handled by non-human agents or virtual agents are referred to herein as “virtual entity communication sessions”. The manager 102 at computing device 104 may be defined as the supervising human agent for call sessions being handled for users. The system 100 may define the manager 102 as being a supervising human agent upon login and suitable authentication. The manager's 102 computing device 104 may include a communications module 124 for communications via network(s) 114. Further, the computing device 104 may include suitable hardware, software, and/or firmware (e.g., memory 126 and one or more processors 128) for handling functionalities described herein.

The functionalities of the communication session manager 122 described herein may be implemented by suitable hardware, software, and/or firmware of the server 120. In an example, functionalities of the communication session manager 122 may be implemented by one or more processors running instructions stored in memory.

A virtual entity communication session may user service or support interactions where the user is connected to, and exchanges messages or communications with a non-human entity such as a software agent, chatbot, user service robot, or automated system over a communication channel. During a virtual entity communication session, the virtual entity may server as the primary conversational participant on the provider side, and may hand off or share the interaction with a human agent. The virtual entity may receive session messages from the customer, processes them using natural language or rule-based logic, and generates answer messages selected from stored service resources. Example virtual entity communication sessions include, but are not limited to, a voice-based virtual entity communication session, an SMS-based virtual entity communication session, a chat-based virtual entity communication session, or the like.

The system 100 may identify one or more virtual entity communication sessions assigned to the supervising human agent at computing device 104. This assignment thereby defines one or more monitored virtual entity communication sessions. The virtual entity may track its own state in the session (e.g., active, suspended, or awaiting escalation) to decide whether to continue handling the interaction or to request intervention by a human agent. If the virtual entity cannot process a message or identify its content, it can suspend its session role and forward the session context and message content to a human user-service endpoint.

The user interface 106 can be controlled to render an interface for the manager 102 that presented monitored virtual entity communication sessions. For example, the computing device 104 can include tools or have access to tools (such as by server 120) for monitoring virtual entity communication sessions. The tools can mirror, analyze, and facilitate the manager 102 to intervene into a virtual entity communication session in real time. The system 100 can continuously inspect the session content against rules or models and surfaces alerts and controls to the human via a monitoring user interface, such as user interface 106. The user interface 106 can be controlled to mirror a live chat or voice transcript between a user and a virtual agent to a supervisor console or “alert monitor” so the manager 102 can view the same messages and timing. Further, the user interface 106 can present metadata such as elapsed time, service level indicators, sentiment scores, and detected questions that the virtual agent is attempting to answer. As a result, the manager 102 can observe, without altering, the customer's experience until intervention is desired. The user interface 106 can provide content and flow information of the conversation and check whether it satisfies predefined rules or thresholds, such as no satisfactory answer after several turns or violation of service-level requirements. In addition, the user interface 106 can be controlled to generate and present messages to the manager's 102 when conditions indicate confusion, escalation risk, inappropriate responses, or the like.

By use of the user interface 106, the manager 102 can select one of the monitored virtual entity communication sessions for monitoring and or involvement. As a result of the selection, a selected virtual entity communication session may be defined. For example, the display 108 of the user interface 106 may display identifications of monitored virtual entity communication sessions, such as the sessions with computing devices 116A, 116B, and 116C. The user interface 106 may provide for user selection of each identified session. For example, the display 108 may display a select button for each identified session whereby the user can select one of the monitored virtual entity communication sessions for involvement. The communication session manager 122 can control the display 108 to render a detail view for the selected virtual entity communication session. In embodiments, the functionalities of the communication session manger 122 may be partially or entirely implemented at the computing device 104.

At least one participant of the selected virtual entity communication session may be a virtual entity. The virtual entity may include a virtual agent and/or a virtual avatar. The virtual avatar may be based, at least in part upon the virtual agent, an avatar visual component and an avatar audio component.

Upon selection of one of the monitored virtual entity communication sessions for involvement, the manager 102 can be enabled to be involved with the selected session via the computing device 104. For example, the manager 102 can be enabled to be involved with the selected session, via the computing device 104, to take over the selected virtual entity communication sessions from a virtual entity. In another example, the communication session manager 122 can enable the computing device 104 for the manager 102 to join the selected virtual entity communication sessions with a virtual entity.

As described in more detail herein, the communication session manager is configured to color code one or more of the monitored virtual entity communication sessions illustrated within the user interface 106. In an example, the communication session manager is configured to sequence the monitored virtual entity communication sessions illustrated within the user interface 106.

In embodiments, systems and computer-implemented methods disclosed herein can implement a dispatch manager that utilizes virtual entities to interact with brokers and carriers, monitor freight opportunities, and electronically secure shipments on behalf of human parties. A dispatch manager as described herein can implement freight dispatcher work processes via automated agents that exchange communications or messages over digital channels. A virtual dispatch broker implemented by the dispatching manager can monitor shipments available for dispatch, for example by reviewing one or more electronic load boards or broker feeds to identify loads that meet defined criteria. The virtual dispatch broker can subsequently define and operate multiple virtual entities (e.g., agents/avatars) that “shop” those available shipments to multiple carriers or, conversely, shop carrier requests to multiple brokers. Each carrier or broker can be associated with an assigned virtual entity that acts as that party's representative in negotiation and acceptance workflows. These virtual entities can communicate with synthesized speech, SMS, email, APIs, and/or the like to present load offers, accept offered terms, or negotiate revised terms before a shipment is accepted. In a broker-to-carrier mode, the dispatching manager can monitor available shipments and virtually “offer” those shipments to carriers via their virtual entities, collecting acceptances or counteroffers. In a carrier-to-broker mode, a carrier can define a desired shipment via its virtual entity, and the virtual dispatch broker can search load boards/brokers for a matching shipment and then communicates with the broker's side (which may also be a broker virtual entity) to secure transport. Human carriers and brokers can remain counterparties, but they interact through their assigned virtual entities, which handle the repetitive communication and transaction steps. Status updates (e.g., shipment status reports) and other events are passed through the virtual dispatch broker so that both sides receive structured, machine-generated updates without needing direct human-to-human contact for every step.

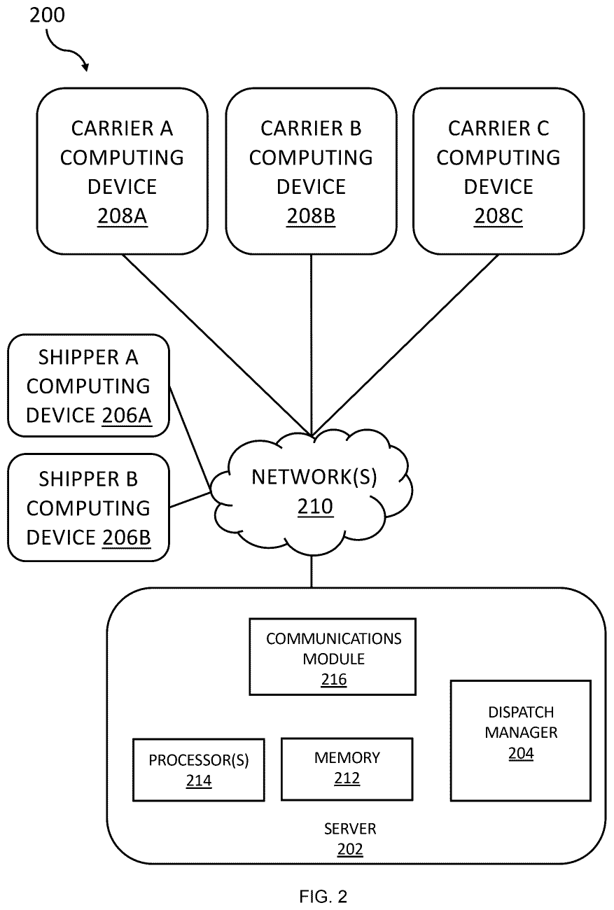

FIG. 2 illustrates a block of virtual dispatching system 200 for monitoring shipments available for dispatch and for engagement of shipment carriers via virtual entities in accordance with embodiments of the present disclosure. Referring to FIG. 2, the system 200 includes a server 202 including a dispatch manager 204. The system 200 also includes computing devices 206A and 206B of shippers A and B with shipments available for dispatch. The shippers A and B may interact with their respective computing device 206A and 206B for identifying shipments available for dispatch. Further, the system 200 includes computing devices 208A, 208B, and 208C of carriers A, B, and C, respectively, that may be available for transport of available shipments. Carriers A, B, and C may interact with their respective computing device 208A, 208B, and 208C for indicating availability for transporting shipments. Computing devices 206A, 206B, 208A, 208B, and 208C may suitably communicate their indications of available shipments and availability for transportation of shipments via one or more communication networks 210.

The dispatch manager 204 may include hardware, software, and/or firmware for implementing its functionalities described herein. For example, the dispatch manager 204 may includes memory 212 and one or more processors 214 for implementing the functionalities. In addition, the dispatch manager 204 may control a communications manager 216 for sending communications to computing devices 206A, 206B, 208A, 208B, and 208C via network(s) 210. Further, communications from computing devices 206A, 206B, 208A, 208B, and 208C via network(s) 210 may be received via communications module 216.

In embodiments, the dispatch manager 204 can use the virtual dispatching system 200 to monitor shipments available for dispatch. For example, the dispatch manager 204 can receive identifications of shipments available for dispatch. These may be the available shipments identified by shippers A and B at computing devices 206A and 206B. In response to identifications of the shipments available for dispatch, the dispatch manager 204 can define virtual entities for shopping the available shipments to carriers, such as carriers A, B, and C at computing devices 208A, 208B, and 208C, respectively.

The virtual entities can interact with brokers and carriers, monitor freight opportunities, and electronically secure shipments on behalf of human parties. In effect, it performs the traditional work of a freight dispatcher but does so through automated agents that communicate over digital channels rather than a human dispatcher making the calls or sending the messages. The virtual dispatch broker monitors shipments available for dispatch, for example by reviewing one or more electronic load boards or broker feeds to identify loads that meet defined criteria. Each carrier or broker can be associated with an assigned virtual entity that acts as that party's representative in negotiation and acceptance workflows. In a broker-to-carrier mode, the virtual dispatching system monitors available shipments and virtually “offers” those shipments to a plurality of carriers via their virtual entities, collecting acceptances or counteroffers. In a carrier-to-broker mode, a carrier defines a desired shipment via its virtual entity, and the virtual dispatch broker searches load boards/brokers for a matching shipment and then communicates with the broker's side (which may also be a broker virtual entity) to secure transport. Status updates (for example shipment status reports) and other events are passed through the virtual dispatch broker so that both sides receive structured, machine-generated updates without needing direct human-to-human contact for every step.

The dispatch manager 204 can identify an interested carrier among the plurality of carriers (e.g., carriers A, B, and C). An interested carrier can be identified when one of the carriers, or its associated virtual entity, affirmatively indicates that it would like to secure a particular available shipment that has been “shopped” to the carriers by the dispatch manager 204. In other words, interest is established when a carrier (or carrier virtual entity) responds to the offered shipment and signals acceptance or a desire to negotiate for that specific load. For example from among the multiple carriers, the dispatch manager 204 can identify an “interested carrier” as the specific carrier that responds via its assigned virtual entity indicating that it wants to secure the available shipment. The interested carrier can communicate with the virtual dispatcher via an assigned virtual entity using synthesized speech, SMS, email, or an API. Through that communication, the carrier may accept the shipment at the broker's offered terms or initiate a negotiation of updated terms before ultimately accepting the shipment, and this response is what causes the system to designate that carrier as the interested carrier for that load.

Further, the dispatch manager 204 can communicate with an interested carrier via an assigned virtual entity, chosen from the virtual entities, to secure transport of the available shipment. For example, communication with an interested carrier via an assigned virtual entity can be implemented as a set of functionalities that (1) map the carrier to a specific virtual agent identity, and (2) generate, send, receive, and interpret messages over one or more communication channels (e.g., voice, text, APIs) on that carrier's behalf. The system can treat the virtual entity as the “endpoint” for that carrier in the dispatch workflow, while the underlying platform handles channel-specific protocols, state, and business logic.

In embodiments, the dispatch manager 204 can enable the virtual dispatching system to review one or more electronic load boards to monitor the shipments available for dispatch. Further, the dispatch manager 204 can enable the virtual dispatching system to interface with one or more brokers to monitor the shipments available for dispatch. The dispatch manager 204 can enable the interested carrier to accept, via the assigned virtual entity, the available shipment at terms defined by a broker associated with the available shipment. Further, the dispatch manager 204 can enable the interested carrier to negotiate, via the assigned virtual entity, updated terms with a broker associated with the available shipment before accepting the available shipment. The dispatch manager 204 can utilize synthesized speech to communicate with the interested carrier to secure transport of the available shipment; utilize SMS communication methodologies to communicate with the interested carrier to secure transport of the available shipment; and/or utilize email communication methodologies to communicate with the interested carrier to secure transport of the available shipment. Further, the interested carrier can be represented by a carrier virtual entity. Further, the dispatch manager 204 can utilize an application program interface to communicate with the interested carrier to secure transport of the available shipment. The dispatch manager 204 can receive an update from the interested carrier concerning the status of the available shipment, thus defining a shipment status report. Further, the dispatch manager 204 can provide the shipment status report to the broker associated with the available shipment.

In embodiments, carriers can communicate with the virtual dispatcher via virtual entities (e.g., agents or avatars). Via these virtual entities, a carrier may define a shipment that they are interested in securing. The virtual dispatcher may then search for this shipment (e.g., via load boards or brokers) on behalf of this carrier. Once a shipment is found, the carrier (or a virtual representative thereof) may communicate with the broker associated with the shipment (e.g., via SMS, email, or synthesized speech) and e.g., accept the shipment at the offered terms or negotiate revised terms before accepting the available shipment.

In embodiments, a dispatch manager can enable a virtual dispatching system to communicate with carriers via a virtual entity assigned to each of the carriers. For example, the dispatch manager 204 can enable communication with carriers A, B, and C at computing devices 208A, 208B, and 208C, respectively, via a virtual entity assigned to each of the carriers A, B, and C. The dispatch manager 204 can receive a request from a specific carrier via an assigned virtual entity for a shipment that the specific carrier would like to secure, thus defining a desired shipment. Further, the dispatch manager 204 can monitor shipments available for dispatch to identify an available shipment that matches the desired shipment, thus defining a matching shipment. The dispatch manager 204 can also communicate with a broker associated with the matching shipment via the assigned virtual entity to secure transport of the matching shipment.

In accordance with embodiments, the dispatch manager 204 can enable the virtual dispatching system to review one or more electronic load boards to monitor the shipments available for dispatch to identify the available shipment that matches the desired shipment. The dispatch manager 204 can also enable the virtual dispatching system to interface with one or more brokers to monitor the shipments available for dispatch to identify the available shipment that matches the desired shipment. Further, the dispatch manager 204 can enable the specific carrier to accept, via the assigned virtual entity, the matching shipment at terms defined by the broker associated with the matching shipment. The dispatch manager 204 can also enable the interested carrier to negotiate, via the assigned virtual entity, updated terms with the broker associated with the matching shipment before accepting the matching shipment. Further, the dispatch manager 204 can utilize synthesized speech to communicate with the broker associated with the matching shipment to secure transport of the matching shipment; utilize SMS communication methodologies to communicate with the broker associated with the matching shipment to secure transport of the matching shipment; and/or utilize email communication methodologies to communicate with the broker associated with the matching shipment to secure transport of the matching shipment. The broker associated with the matching shipment is represented by a broker virtual entity. The dispatch manager 204 can utilize an application program interface to communicate with the broker associated with the matching shipment to secure transport of the available shipment. Further, the dispatch manager 204 can receive an update from the specific carrier concerning the status of the matching shipment, thus defining a shipment status report. The dispatch manager 204 can provide the shipment status report to the broker associated with the matching shipment. Further details of these functionalities are described herein.

In accordance with embodiments, systems and computer-implemented methods disclosed herein can generate a virtual avatar for representing a human agent. This virtual entity may be enhanced with the use of synthetic visual representations (of the human agent) and synthetic audio representations (of the human agent) to form the virtual avatar, wherein this virtual avatar may be utilized to, for example, attend meetings, gather information, distribute information and/or the like on behalf of the human agent. As an example, a virtual avatar may be generated to represent a human agent at one of the computing devices 118A or 118B shown in FIG. 1.

The communication session manager 122 or other functionalities of the system 100, for example, can generate the virtual agent to represent a human agent as a computer-implemented process that builds a synthetic “avatar” from that human's real visual and audio samples, and subsequently use that avatar as the person's stand-in in digital interactions. The virtual avatar can be based on an underlying virtual agent plus an avatar visual component and an avatar audio component. Further, the communication session manager 122 can effectuate a virtual avatar based, at least in part upon the virtual entity, the avatar visual component and the avatar audio component.

In embodiments, the communication session manager 122 can enable the virtual avatar to engage in a virtual meeting on behalf of known human agent. Further, the communication session manager 122 can enable the virtual avatar to engage in a virtual meeting on behalf of known human agent. The virtual meeting can be, for example, between the virtual avatar and one or more of a shipper, a broker, a dispatcher, and a carrier. The communication session manager 122 can enable the virtual avatar to gather information during the virtual meeting, thus defining gathered information. Further, the communication session manager 122 can enable the virtual avatar to provide some or all of the gathered information to an interested entity. The communication session manager 122 can enable the virtual avatar to distribute information during the virtual meeting, thus defining distributed information. Further, the communication session manager 122 can enable the virtual avatar to respond to questions asked during a virtual meeting. The communication session manager 122 can enable the virtual avatar to access one or more datastores so that the virtual avatar obtains some or all of the distributed information and/or respond to the questions asked during a virtual meeting. Further, the communication session manager 122 can use generative artificial intelligence to generate the synthetic visual representation of the known human agent based, at least in part, upon the visual samples of the known human agent. The communication session manager 122 can also use generative AI to generate the synthetic audio representation of the known human agent based, at least in part, upon the voice samples of the known human agent. Further details of these functionalities are described herein.

In embodiments, systems and computer-implemented methods disclosed herein can implement utilization of multiple virtual entities to accomplish a task. For example, a group of virtual entities may be defined, wherein each of these virtual entities may have one or more unique skills. Therefore, if a task needs to be accomplished that requires a group of skills that are not possessed by a single virtual entity, a group of virtual entities may be assembled that collectively have the group of skills required to accomplish the task. This group of virtual entities may be utilized simultaneously or sequentially.

In an example, multiple virtual entities of different skills can be coordinated to function as a “team” of specialized agents that collectively complete a single overall task (such as securing a load, resolving a call, or supporting a workflow), with each virtual entity handling the portions that match its configured capabilities. The system can orchestrate these virtual entities so that responsibility can move between them, or they can contribute in parallel, while the user and the underlying task see a single continuous experience. In an example, a virtual agent can be configured with a different skill and functionality, such as a customer-facing AI call agent that speaks with carriers or customers. In another example, virtual entity can be a data/analytics agent that queries dashboards, runs analytics, or simulates scenarios. Each virtual entity can be optimized for particular subtasks such as negotiation, information retrieval, sentiment analysis, or recommendation, rather than one monolithic bot doing everything.

In embodiments, during a live task (e.g., handling a call about a shipment), one virtual entity conducts the primary interaction while another virtual entity fetches historical data, performs analysis, or surfaces recommendations in real time. The “support” virtual entity can, for instance, respond to queries like “show me this carrier's history” or “simulate the impact of giving this rate,” and provide those results directly into the workflow the main agent is managing. An interactive dashboard serves as the coordination layer that exposes both the ongoing task (such as a flagged call) and the tools of the auxiliary virtual entities to the human representative. Through this dashboard, a representative can use a virtual assistant entity to pull analytics, recommendations, or context, and then either let the primary AI agent proceed or take over the interaction, all within the same task context. From the business perspective, a single task is accomplished: a call is resolved, a shipment is booked, or an issue is handled, but under the hood multiple virtual entities with different skills have contributed (monitoring, analysis, recommendations, and front-line interaction). This design allows complex tasks to be completed more effectively by dividing work across specialized virtual entities while maintaining a unified, seamless experience for both users and customers.

In embodiments, the communication session manager 122 or other functionalities described herein can define multiple virtual entities. Each of the virtual entities can have one or more unique skillsets. Further, the communication session manager 122 can initiate a virtual session for a user. The user can request a task that requires multiple unique skillsets, thus defining a group of required skillsets. The communication session manager 122 can identify a group of agents that collectively possess the group of required skillsets. Further, the communication session manager 122 can involve the group of agents in the virtual session so that the task requested by the user can be accomplished.

In embodiments, the communication session manager 122 can sequentially involve the group of agents in the virtual session so that the task requested by the user can be accomplished. Further, the communication session manager 122 can simultaneously involve the group of agents in the virtual session so that the task requested by the user can be accomplished. A portion of the unique skillsets of the virtual entities partially overlap. The communication session manager 122 can also initiate the virtual session in response to a request by the user. The skillsets of the virtual entities are compartmentalized. The skillsets of the virtual entities can be compartmentalized to enhance security. Further, the skillsets of the virtual entities can be compartmentalized to enhance performance. The one or more of the virtual entities can be a virtual avatar. The virtual avatar can be based, at least in part upon a virtual entity, an avatar visual component, or an avatar audio component.

In embodiment, systems and computer-implemented methods disclosed herein can track content across multiple modalities. Particularly for example, communication channels may be established for a user that utilize various communication modalities (e.g., voice-based; SMS-based; chat-based; and email-based. Each of these communication modalities may generate separate and distinct data sets. These separate and distinct datasets may then be combined to form a multi-modal dataset for that user that provides a complete history of the communications in which the user engaged. This multimodal dataset may then be reviewed, summarized, and processed.

Content can be tracked across multiple modalities by converting different input forms (e.g., audio, text, and analytics signals) into structured, time-aligned data that can be monitored, analyzed, and re-used within one integrated system. This enables the platform to keep a coherent view of “what is happening” across voice conversations, text interactions, and dashboard/analytics interactions in real time. Live calls handled by AI agents are captured as audio streams and processed into real-time transcriptions, so spoken words become text that can be searched, flagged, and analyzed. Additional audio features such as amplitude, pitch variation, and speech rate are extracted to quantify intensity and emotional energy (e.g., subtle, mild, moderate, intense, extreme). The text modality includes transcribed speech and direct text inputs (chat, SMS, emails, in-app), all normalized into a common representation. NLP models perform sentiment analysis, emotion classification, keyword and entity extraction, producing structured signals like sentiment scores, emotional labels, and conversation scores. These audio- and text-derived signals are visualized as dashboards, color-coded alerts, conversation scores, and time-based indicators that track how the interaction evolves. The system can be queried about analytics (e.g., call volume trends, profit margins), and the system turns those analytics results into visual elements (charts, graphs, and reports) linked back to the underlying interaction data. All modalities—audio features, transcriptions, emotions, sentiment, alerts, and analytics—are timestamped and stored so that a representative can review the full interaction history across channels in a unified view. This unified tracking lets the system compute and update a single “conversation score” and other metrics that summarize the state of the interaction by aggregating signals from multiple modalities over time.

In embodiments, a communication session manager, such as the communication session manager 122 shown in FIG. 1, or other functionalities described herein can define communication modalities. Further, the communication session manager can engage in a first communication session for a user via a first communication modality chosen from the communication modalities. The communication session manager can generate a first session data set based, at least in part, upon the first communication session. Further, the communication session manager can engage in at least a second communication session for the user via at least a second communication modality chosen from the plurality of communication modalities. The communication session manager can also generate at least a second session data set based, at least in part, upon the second communication session. Further, the communication session manager can combine the first session data set and the at least a second session data set to form a multi-modal user data set.

In embodiments, systems and computer-implemented methods disclosed herein can generate a virtual entity to train human agents. For example, a virtual entity may be utilized to interact with humans. Feedback of these interactions may be received and subsequently used to train the virtual entity and define best practices. Once fully trained, the virtual entity may be utilized to train human agents via single mode or multi-modal training sessions (e.g., voice-based training; SMS-based training; chat-based training; and email-based training). These functionalities may be implemented by a communication session manager 122 or other functionalities described herein.

In embodiments, a virtual entity can be generated to train human agents by creating a chatbot-style virtual customer that simulates realistic interactions and scenarios. These simulations may be used to practice, evaluate, and improve human agent performance. The virtual entity can be integrated with analytics and an interactive dashboard so training is data-driven and closely mirrors production conditions. In an example, a virtual assistant can play the role of a customer or counterparty, asking questions, raising objections, and following scripted or AI-generated scenarios. Further for example, the virtual entity can simulate domain-specific situations (e.g., logistics issues, rate negotiations, complex technical questions) so that human agents can rehearse realistic conversations in a controlled environment. Human agents can interact with the virtual entity through the same channels used in real operations (e.g., voice, chat, or dashboard-driven workflows), practicing how to respond, de-escalate, and resolve issues. The system can run “what-if” or predictive scenarios based on historical data, letting the virtual entity pose situations that reflect real patterns (e.g., typical objections or edge cases), which the trainee must handle. During and after training sessions, analytics such as sentiment, conversation score, timing, and resolution outcomes are computed for the human agent's interaction with the virtual entity. These metrics, along with transcripts and highlighted moments, are presented through the dashboard so trainers and agents can review performance, identify gaps, and iteratively improve skills using repeated practice with the virtual entity

In embodiments, the communication session manager 122 of FIG. 1 can utilize a virtual entity to assist in a plurality of communication sessions with multiple users. Further, the communication session manager 122 of FIG. 1 can obtain feedback concerning the manner in which the virtual entity interacts with the plurality of users, thus defining entity-specific feedback. The communication session manager 122 can utilize the entity-specific feedback to define best practices for the virtual entity to improve the manner in which the virtual entity will interact with future users, thus defining virtual entity best practices. The communication session manager 122 can enable the virtual entity to train a human agent based, at least in part, upon the virtual entity best practices.

In embodiments, the communication session manager 122 can enable the virtual entity to roll play with the human agent based, at least in part, upon the virtual entity best practices. Further, the communication session manager 122 can enable the virtual entity to play the role of a synthetic user so the manner in which the human agent interacts with the synthetic user may be scored based, at least in part, upon virtual entity best practices. The communication session manager 122 can also provide feedback to the human agent concerning the manner in which the human agent interacted with the synthetic user. Further, the communication session manager 122 can initiate a training session between the virtual entity and the human agent. The communication session manager 122 can utilize additional-entity feedback to further define best practices for the virtual entity to further improve the manner in which the virtual entity will interact with future users, thus refining the virtual entity best practices. Example training sessions include, but are not limited to, a voice-based training session; an SMS-based training session; a chat-based training session; and an email-based training session. A training session can be a multimodal training session. The virtual entity can be a virtual agent, or a virtual avatar. The virtual avatar can be based, at least in part upon the virtual agent, an avatar visual component and an avatar audio component.

In embodiments, systems and computer implemented-methods disclosed herein can utilizing phrase-based voice authentication. Particularly for example, once a communication session is initiated with a user and the client is identified (e.g., by providing a username/password/identifying information), the user can be provided with a bespoke passphrase that they are required to say within a defined period of time. Being the passphrase is bespoke, a computer may not be preprogrammed to spoof the voice of the user. Additionally, being the user is required to say the passphrase within a defined period of time, a bad actor may not have enough time to type the passphrase into a spoofing computer so that a user's voice may be replicated saying the passphrase. Once this bespoke passphrase is spoken by the user, it may be processed so that the user may be authenticated via voice-based authentication technology.

In embodiments, phrase-based voice authentication can be utilized by combining a dynamic spoken passphrase with biometric verification of the speaker's voice, so both “what is said” and “who is saying it” are checked in the same step. This can be implemented as a two-factor process that uses speech-to-text for phrase verification and deep-learning models (e.g., convolutional autoencoders) for voice authentication. For each authentication session, the system can generate a random, human-readable passphrase and delivers it to the user via SMS, email, or app notification. The user must then speak this specific passphrase aloud, ensuring the phrase is session-unique and mitigating risks associated with static credentials or replayed audio. The spoken audio can be recorded, converted into a spectrogram, and processed in two parallel ways: (1) speech-to-text confirms that the spoken phrase matches the generated passphrase; and/or (2) a user-specific convolutional autoencoder evaluates whether the voice characteristics match the enrolled user. Each user has a CAE trained only on that user's voice, producing low reconstruction error for the legitimate user and high error for impostors or cloned voices; a threshold on this error determines acceptance. The system may preprocess audio (resampling, noise reduction, VAD), converts it to spectrograms (e.g., STFT, Mel spectrograms, MFCCs), normalizes and pads them, then feeds them into the CAE. Data augmentation (noise, time-stretching, pitch shifting) and advanced ML techniques (speaker embeddings, anti-spoofing, liveness detection) improve robustness to noise, voice variability, and deepfake attacks. Because the passphrase is dynamic and the CAE is user-specific, attackers must both know the current phrase and convincingly replicate the user's voice in real time, which significantly raises the bar for fraud.

In embodiments, a communication session manager (such as communication session manager 122 shown in FIG. 1) can initiate a communication session with a user. Further, the communication session manager 122 can receive identifying information from the user during the communication session. The communication session manager 122 can determine that the identifying information is accurate. Further, the communication session manager 122 can provide the user with a bespoke passphrase in response to determining that the identifying information is accurate. The communication session manager 122 can require the user to say the bespoke passphrase within the communication session within a defined period of time, thus defining a spoken passphrase. Further, the communication session manager 122 can process the spoken passphrase using a voice-based identification process to confirm the identity of the user in response to receiving the spoken passphrase.

In embodiments, the communication session includes a voice-based communication session. Further, the identifying information can include a username, a user identifying number, or a user phone number. The communication session manager can provide the user with a bespoke passphrase using an alternate communication modality. Further, the alternate communication modality can be one or more of an SMS-based communication modality, a chat-based communication modality, or an email-based communication modality. The voice-based identification process can include one or more of a convolutional autoencoder process, a long short term memory process, or a time delay neural network. The defined period of time can be a period of predefined time to prevent the spoofing of the voice-based identification process. Further, the communication session manager can ask the user to re-provide the identifying information if the identifying information is not accurate. The communication session can utilize one or more of a virtual agent, and a virtual avatar. The virtual avatar can be based, at least in part upon the virtual agent, an avatar visual component and an avatar audio component.

In embodiments a unified satisfaction score can be generated for each of multiple, virtual-entity communication sessions. These communication sessions and their related unified satisfaction scores may be visually represented with a user interface. These unified satisfaction scores may be based upon various satisfaction metrics, such as a sentiment analysis metric; an emotion analysis metric; a volume analysis metric; a pitch analysis metric; a stress analysis metric; and a key word analysis metric. A supervising human agent may be enabled to select a specific virtual-entity communication session and become involved in the same (e.g., by taking over the virtual-entity communication session or joining the virtual-entity communication sessions).

A unified satisfaction score can be generated by aggregating multiple real-time signals from an interaction—sentiment, emotion, intensity, and temporal dynamics—into a single, continuously updated metric that reflects overall conversation quality. This unified score is used on the dashboard to help representatives quickly see which interactions are healthy and which need attention. NLP models compute text sentiment (very positive to very negative), detect emotions (e.g., anger, joy, fear, sadness), and track repetition or confusion in the dialogue. Audio analysis derives intensity measures from amplitude, pitch variation, and speech rate, classifying speech as subtle, mild, moderate, intense, or extreme. These different features can be combined into a “conversation score” that summarizes sentiment, mood, intensity, and how they change over time into a single numeric value. The score is mapped to intuitive ranges with color codes (e.g., green for high satisfaction, yellow for average, orange for problematic, red for critical) so it can be interpreted at a glance. As the interaction progresses, the underlying models continuously update sentiment, emotion, and intensity, and the conversation score is recomputed accordingly. The score can be displayed on the interactive dashboard along with alerts, enabling agents to prioritize interventions and assess whether satisfaction is improving or deteriorating during and after the call.

In embodiments, a communication session manager (such as the communication session manager 122 shown in FIG. 1) can generate the unified satisfaction score. The communication session manager 122 can identify multiple virtual entity communication sessions to be monitored, thus defining a plurality of monitored virtual entity communication sessions. Further, the communication session manager 122 can calculate a unified satisfaction score for each of the plurality of monitored virtual entity communication sessions, wherein the unified satisfaction score spans a plurality of satisfaction metrics. The communication session manager 122 can render a user interface that illustrates the plurality of monitored virtual entity communication sessions and their related unified satisfaction scores.

In embodiments, the monitored virtual entity communication sessions are assigned to a supervising human agent. Further, the communication session manager can enable the supervising human agent to select one of the monitored virtual entity communication sessions based, at least in part, upon the unified satisfaction score, thus defining a selected virtual entity communication session; and involve the supervising human agent in the selected virtual entity communication session. Further, the communication session manager can enable the supervising human agent to take over the selected virtual entity communication session from a virtual entity. The communication session manager can enable the supervising human agent to join the selected virtual entity communication session with a virtual entity. Further, the selected virtual entity communication session can include one or more of: a voice-based communication session, an SMS-based communication session, a chat-based communication session, and an email-based communication session. Further, the communication session manager can calculate a value for each of the plurality of satisfaction metrics, thus defining calculated metric values; assign a weight to each of the plurality of calculated metric values, thus defining weighted metric values; and calculate the unified satisfaction score based, at least in part, upon the plurality of weighted metric values. Example satisfaction metrics include, but are not limited to, a sentiment analysis metric, an emotion analysis metric, a volume analysis metric, a pitch analysis metric, a stress analysis metric, and a key word analysis metric. The monitored virtual entity communication sessions can utilize one or more of a virtual agent and a virtual avatar. The virtual avatar can be based, at least in part upon the virtual agent, an avatar visual component and an avatar audio component.

In embodiments, a user interface can be render for enabling a supervising human agent to visually monitor multiple, virtual entity communication sessions (e.g., an SMS session, an email session, or a synthesized speech session) that are being handled by multiple, virtual entities. These communication sessions may be color-coded or sequenced when rendered within the user interface, thus identifying one or more sessions that require supervisor intervention. If a session is selected, a supervising human agent may become involved in the same (e.g., by taking over the virtual-entity communication session or joining the virtual entity communication sessions).

Sessions requiring supervisor attention can be identified by continuously analyzing live interactions for risk and quality signals, then flagging and prioritizing those that cross defined thresholds so supervisors can intervene quickly. This is driven by real-time analytics (sentiment, intensity, repetition, confusion) that feed into alerts and a unified conversation score visible on the dashboard. Ongoing calls and AI-handled sessions are transcribed in real time, with NLP models computing sentiment, emotional tone, and detecting repeated questions or signs of confusion. Audio signal processing measures intensity (amplitude, pitch variation, speech rate), and these factors are aggregated into a conversation score that reflects how well the session is going. Predefined parameters (e.g., strongly negative sentiment, high intensity, escalating misunderstandings, mention of critical issues like deadlines or disputes) are used as escalation triggers. When these conditions are detected, the system automatically flags the session and generates color-coded alerts (e.g., yellow for emerging issues, red for critical situations) indicating that supervisor or senior representative attention may be needed. Flagged sessions appear in an interactive queue on the dashboard, sortable by urgency, sentiment, conversation score, issue type, or duration. This lets supervisors and experienced agents quickly identify which sessions require immediate review or takeover versus those that can be monitored passively. For high-risk sessions, a supervisor can use a Take Over control to join or assume the interaction, with full access to the live transcript, score history, and key highlights so intervention is informed. Afterward, analytics on flagged sessions (e.g., reasons for escalation, timing, outcome) are used to refine thresholds and models, improving the system's ability to detect sessions needing supervisor attention in the future.

In embodiments, a communication session manager (such as communication session manager 122 shown in FIG. 1) or other functionalities described herein can identify sessions requiring supervisor attention. The communication session manager 122 can identify a plurality of virtual entity communication sessions to be monitored, thus defining multiple, monitored virtual entity communication sessions. The communication session manager 122 can rank the plurality of monitored virtual entity communication sessions based, at least in part, upon a satisfaction score, thus defining multiple, ranked virtual entity communication sessions. Further, the communication session manager 122 can render a user interface that illustrates the ranked virtual entity communication sessions. The communication session manager 122 can identify at least one of the ranked virtual entity communication sessions that requires supervisor involvement based, at least in part, upon the satisfaction score, thus defining an identified virtual entity communication session.

In embodiments, the monitored virtual entity communication sessions can be assigned to a supervising human agent. Further, the communication session manager can enable the supervising human agent to get involved in the identified virtual entity communication session. The communication session manager can enable the supervising human agent to take over the identified virtual entity communication session from a virtual entity. Further, the communication session manager can enable the supervising human agent to join the identified virtual entity communication session with a virtual entity. The identified virtual entity communication session can include one or more of: a voice-based communication session, an SMS-based communication session, a chat-based communication session, and an email-based communication session. Further, the communication session manager can color code one or more of the ranked virtual entity communication sessions illustrated within the user interface. The communication session manager configured to sequence the ranked virtual entity communication sessions illustrated within the user interface. The monitored virtual entity communication sessions can utilize one or more of a virtual agent, and a virtual avatar. The virtual avatar is based, at least in part upon the virtual agent, an avatar visual component and an avatar audio component.

### Live Call TakeOver

In embodiments, systems and computer-implemented methods disclosed herein provide live call takeover functionalities. These functionalities can bridge the gap between AI-driven automation and human-led customer service. Systems disclosed herein can operate in real-time, enabling human representatives to monitor, intervene, and manage live calls that are initially handled by AI agents. The interactive nature of the dashboard can make the entire process efficient and user-friendly. Details of implementation of these functionalities are set forth herein.

Effective call monitoring can ensure human representatives stay informed about ongoing conversations. Interactive dashboard and user interfaces described herein can be central to this process. In embodiments, human representatives can access a live dashboard that streams ongoing calls handled by AI agents. The interactive dashboard can provide a comprehensive view of active conversations, including key customer details such as name, account history, and reason for the call. Real-time transcription of the conversation can allow representatives to follow the discussion without interrupting the customer experience. The transcription can include timestamps and highlights key phrases or terms flagged by the AI for potential escalation.

Advanced sentiment analysis can be integrated into the monitoring system, providing visual indicators (e.g., color-coded alerts, sentiment scores, conversation scores) to signal when a call requires attention. These alerts are triggered by predefined parameters such as customer frustration, repeated inquiries, or mentions of critical issues like deadlines or disputes. The conversation score can aggregate text sentiment, conversation mood, speech intensity, and temporal changes into a single metric intensity, and temporal changes into a single metric. The main benefit of the conversation score is that it captures the state of the conversation in a single, easy-to-interpret metric. This simplicity allows for efficient visual tracking and monitoring, enabling representatives to quickly identify conversations that require attention without delving into multiple detailed analytics. By aggregating sentiment, mood, intensity, and temporal dynamics, the conversation score can provide a comprehensive yet digestible snapshot of the interaction's quality, empowering users to act proactively and prioritize effectively.

Examples of color-coded alerts include, but are not limited to, sentiment-based alerts, urgency levels, repetition and confusion indicators, escalation and priority alerts, and conversation score indicators. For sentiment-based alerts for example, green can indicate positive or neutral sentiment, signaling no immediate action is needed; yellow can indicate slight customer dissatisfaction or mild confusion, prompting monitoring for potential escalation; and red can highlight or indicate strong negative sentiment, such as frustration or anger, requiring immediate intervention. For urgency levels for example, blue can denote routine calls with no urgency, such as account inquiries or general questions; orange can flag time-sensitive issues, such as shipment delays or upcoming deadlines; and red can mark critical situations like service outages or disputes that need immediate resolution. For repetition and confusion indicates for example, light yellow can highlight or indicate repetitive questions or confusion in customer responses, suggesting the AI needs support; and dark yellow can indicate a pattern of escalating misunderstandings, signaling potential intervention. For escalation and priority alerts for example, gray can indicate low-priority flagged calls for review, such as minor deviations in protocol; and bright red can indicate critical calls escalated for immediate human review due to issues like policy violations or irate customers. For conversation score indicators for example, green (90-100) can indicate an excellent conversation with consistent positive sentiment, low intensity, and a stable mood over time (e.g., a customer feels understood and expresses satisfaction throughout the call); light green (75-89) can indicate a conversation, though there may be minor fluctuations in mood or sentiment (e.g., a few moments of mild confusion resolved quickly by the AI or representative); yellow (50-74) can highlight an average conversation where issues like moderate intensity or temporary negative sentiment occurred (e.g., a customer starts with slight frustration but is gradually reassured through effective responses); orange (40-49) can signal a problematic conversation with heightened intensity, frequent mood swings, or prolonged periods of negative sentiment (e.g., a customer struggles to get their point across expressing increasing dissatisfaction before intervention); red (below 30) can denote a critical conversation requiring immediate attention due to intense, sustained negative sentiment and unstable mood patterns (e.g., a irate customer with escalating frustration demands action, indicating potential escalation or a service failure). Representatives can use interactive filters and sorting tools to prioritize calls by urgency, duration, or sentiment, enabling a targeted and efficient approach to addressing customer needs.

In embodiments, a takeover mechanism can facilitate a seamless transition from AI to human interaction using intuitive interactive features. In examples, a “Take Over” button is prominently available in the dashboard, at the call level, allowing representatives to assume control of the call instantly. The transition from AI to human can be seamless, ensuring minimal disruption for the customer. An agent can provide a brief handoff message to inform the customer about the transition. Behind the scenes, the AI agent can simultaneously provide the representative with a concise summary of the call, including key details such as the customer's issue, sentiment indicators, and any prior interactions. This ensures the representative is fully prepared to address the customer's concerns.

Regarding context preservation, this functionality can ensure that representatives are fully informed. The interactive dashboard enhances context-sharing. The system can retain the complete conversation history, including transcription and AI-handled interactions, which is instantly visible to the representative upon taking over. This ensures the representative has full context and can address the customer's concerns without the need for repetition. Interactive visual annotations, such as clickable highlights or timestamps for key moments, can be provided to streamline the representative's review process.

Proactive escalation can empower representatives to handle critical situations promptly. Interactive features can make prioritization and response more efficient. In scenarios where the AI detects escalating sentiment, ambiguity, or customer frustration, the system can automatically flag the call for human review. Further, representatives can view flagged calls in an interactive queue, sorted by urgency or type of issue, ensuring prompt and effective intervention. The escalation system can include categorization (e.g., urgency levels or specific issue types) and interactive sorting options to assist in effective resource allocation.

Integrated tools can provide representatives with real-time resources to enhance their performance, accessible through an interactive dashboard. The dashboard can include integrated tools such as FAQs, customer profiles, and relevant documentation to assist representatives in real-time. In examples, AI suggestions and insights can support a representative during the call, providing interactive prompts or recommendations based on the conversation. In other examples, a knowledge base with quick search capabilities can be embedded, enabling representatives to interactively access specific information relevant to the customer's query without delay.

In embodiments, comprehensive analytics can enable businesses or other organizations to measure and improve their service quality. Interactive reporting tools can provide detailed insights. In examples, post-call analytics can provide insights into the reasons for human intervention, call outcomes, and customer satisfaction. In other examples, interactive reports can include metrics such as average intervention time, sentiment changes pre- and post-intervention, and overall resolution rates. In other examples, feedback loops can be enhanced with interactive tools, allowing representatives to flag recurring issues and annotate calls, helping to refine AI responses and identify trends for future improvements. By combining real-time monitoring, seamless transitions, and robust support tools through an interactive dashboard, this system ensures that businesses can deliver high-quality customer service while maximizing the efficiency and capabilities of their AI agents.

Implementing live call takeover functionality can involve several technical considerations to ensure reliability, scalability, and compliance. Each of these aspects can be important to delivering a robust, user-friendly, and effective system that supports both customers and representatives. Handling data in real-time can be important for ensuring smooth communication and monitoring. Low-latency processing of audio streams and transcriptions may be important to ensure representatives can monitor and respond without delays.

In embodiments, advanced streaming protocols, such as WebRTC, can be utilized for real-time audio transmission. For processing, a combination of cloud-based tools and technologies, such as Kafka, JetStream or Apache Flink, can ensure efficient data streaming. Pre-trained and fine-tuned NLP models can be deployed for sentiment analysis, entity recognition, and keyword extraction. Leveraging frameworks, such as Hugging Face Transformers or TensorFlow, can enhance speed and accuracy. Utilization of NLP models can be used to gauge customers' overall sentiment (e.g., very positive, positive, neutral, negative, or very negative) throughout a call. This can be achieved with tools such as Hugging Face Transformers or OpenAI models that are fine-tuned on sentiment datasets. Sentiment data can be visualized in real-time to help representatives prioritize calls.

For emotional analysis, the system may incorporate models that classify nuanced emotional states such as basic (e.g., anger, surprise, disgust, joy, fear, sadness) and others. Techniques such as emotion detection with multi-class classification models enhance the system's ability to detect and act on complex emotions.

For intensity measurement, the system may add an intensity score to sentiment and emotion classifications, specifically evaluating the sound or speech for categories such as subtle, mild, moderate, intense, and extreme. This score can help to categorize the urgency and emotional depth of the interaction. As an example, audio signal processing can leverage techniques such as amplitude analysis, pitch variation detection, and speech rate measurements to quantify intensity levels. In another example, a categorization framework can use models trained on labeled datasets to map audio features to predefined categories (e.g., subtle, mild, moderate, intense, extreme). Each category reflects increasing levels of emotional energy or urgency. For implementation, tools such as OpenSMILE, Praat, or LibRosa can be employed for detailed acoustic feature extraction. Integrate these with machine learning models that predict the intensity category in real time. Visualize the intensity level on the dashboard to enable quicker representative action and prioritization. Suitable frameworks such as TensorFlow and PyTorch can be leveraged for model development and Hugging Face's pre-trained pipelines for rapid deployment. Fine-tune these models with domain-specific datasets to achieve higher accuracy and contextual relevance.

Scalability can ensure that the system can handle varying loads efficiently. The system may be scaled in this instance to handle thousands of concurrent calls during peak usage times. The system can employ auto-scaling cloud infrastructures from providers like AWS, Google Cloud, or Azure to dynamically allocate resources. Load balancing tools, such as HAProxy or AWS Elastic Load Balancer, can distribute traffic effectively across servers. The system may use distributed databases like Amazon Aurora or Google Spanner to ensure fast data access and consistency.

Regarding security and compliance, sensitive data protection and meeting legal standards can be critical in applications described herein. End-to-end encryption and compliance can be met with use of standards like GDPR, HIPAA, and CCPA. Secure communication channels can be provided using TLS/SSL for all data transmissions. Data can be encrypted at rest using AES-256 encryption. Regular penetration testing and security audits can ensure ongoing compliance. multi-factor authentication (MFA) and role-based access controls (RBAC) can be implemented to protect sensitive information.

Integration with existing tools and systems can ensure smooth workflows. Compatibility can be provided with Customer Relationship Management (CRM) platforms, Transportation Management Systems (TMS), telephony systems, and support tools. APIs and SDKs can be used to enable bidirectional communication. Middleware solutions like MuleSoft or Zapier can facilitate complex integrations. Webhooks can ensure real-time updates between connected systems.

Regarding user experience, a user-friendly interface is essential for effective adoption of the systems and computer-implemented methods disclosed herein. Minimal training and an intuitive layout should be provided. Design frameworks like Material Design or Bootstrap can be applied to create responsive and clean interfaces. Interactive dashboards may include drag-and-drop elements, searchable logs, and contextual help features. User may be allowed to provide feedback directly within the platform for continuous UI/UX improvements.

AI models may evolve based on user feedback, customer/client usage, and performance analytics.

Active learning pipelines can be established to update models with flagged data. Tools like TensorFlow Extended (TFX) or MLflow may be used to automate and monitor training workflows. A/B testing may be incorporated to validate model improvements before deployment. By addressing various technical considerations in detail, the live call takeover functionality can offer a secure, scalable, and highly efficient solution for businesses, enhancing customer satisfaction and operational performance.

Systems and computer-implemented methods disclosed herein can provide an innovative and engaging AI-powered virtual assistant integrated into a dashboard to enhance user experience and demonstrate the system's capabilities. It serves as both a functional guide and a dynamic tool for users, providing interactive assistance across various domains. Designed as a friendly and energetic robot, a virtual agent as described herein makes dashboard navigation intuitive and enjoyable while showcasing the advanced capabilities of agentic AI. A virtual agent as described herein can simplifies the navigation process by offering interactive guidance and support. The virtual agent provides step-by-step guidance on how to use the dashboard's tools and services. It interacts with users in real-time, answering questions and providing detailed explanations for dashboard features. It helps onboard new users by demonstrating core functionalities, ensuring they quickly become proficient with the system. This includes video tutorials, voice-assisted instructions, and interactive walk-throughs. Users can ask BadAsk questions about features, tools, or troubleshooting directly using voice commands or text input. This ensures immediate help is always accessible.

Extracting meaningful insights from analytics can be complex. A virtual agent can integrate advanced data-querying capabilities to simplify this process. A virtual agent can integrate seamlessly with the dashboard's analytics and reporting capabilities, enabling users to query and visualize data effortlessly. Users can query data-related insights, such as “How many loads were booked yesterday?” or “Show me the call volume trend for the past three months.” These queries are answered with charts, graphs, or summaries tailored to the user's needs. It can perform data comparisons, trend analysis, and visualization tasks, akin to tools like PowerBI, directly from the dashboard. Users can also request customized reports or export specific datasets for external analysis. Voice interactions can add a layer of accessibility and convenience for users who prefer hands-free operation.

In accordance with embodiments, voice interaction can be provided for user interface. Users can communicate with systems disclosed herein using natural voice commands, enabling seamless interaction without requiring manual input. This feature is particularly useful in multitasking scenarios. Speech recognition can be used to understand complex queries and provides clear, spoken responses. Its ability to interpret context and adapt its responses ensures a conversational experience. Voice interface can be customizable, allowing users to set preferences such as language, tone, and interaction style to match their workflow.

Custom recommendations and insights can be presented by systems disclosed herein. Leveraging its integration with analytics, systems disclosed herein can provide actionable insights and personalized recommendations. Based on analytics, systems disclosed herein provide proactive insights, such as identifying performance gaps, recommending improvements, or highlighting trends that align with the user's goals. It highlights significant trends, anomalies, or key metrics that require attention. For example, systems disclosed herein can notify users of a drop in customer satisfaction scores and suggest areas to investigate. The ability of systems disclosed herein to learn from past interactions allows it to offer increasingly relevant recommendations over time.

Systems disclosed herein can have a “personality” designed to make interactions enjoyable and engaging, fostering user trust and confidence in the dashboard. The personality can friendly and dynamic to foster an interactive and enjoyable user experience, making complex operations more approachable. Its responses are not only informative but also empathetic, enhancing user satisfaction. Its ability to answer domain-specific questions or simulate scenarios further showcases the dashboard's capabilities. For instance, users can ask systems disclosed herein to role-play a customer interaction or run predictive scenarios based on historical data. By engaging users in a conversational and approachable manner, systems can ensure that even non-technical users can effectively utilize advanced dashboard features.

The integration of the interactive dashboard with systems disclosed and the live call takeover functionality can provide a unified and seamless user experience. Systems disclosed herein can act as a central hub for users to interact with the dashboard, providing guidance and answering queries, while the takeover functionality ensures human intervention when necessary. This synergy allows users to navigate complex workflows effortlessly while maintaining high service quality.

Through the dashboard, representatives can monitor ongoing calls in real-time and leverage system capabilities to analyze data or fetch context-sensitive information. For instance, while viewing a flagged call, a representative can ask the system for historical customer interactions, relevant analytics, or sentiment trends to inform their approach before taking over. This real-time assistance ensures that representatives are fully prepared to address customer concerns efficiently.

Additionally, systems disclosed herein can enhance the effectiveness of takeover functionality by offering actionable insights during and after calls. It can provide recommendations for handling specific scenarios, analyze the impact of interventions, or generate performance reports. This integration not only streamlines operations but also empowers representatives to make data-driven decisions, resulting in improved customer satisfaction and operational success. Its multifaceted capabilities make it an indispensable tool for navigating the dashboard and leveraging its full potential.

In an example scenario, there may be rate negotiation misunderstanding in a call. In this example, a carrier calls to book a load and attempts to negotiate the rate. The AI agent provides standard responses, but miscommunication arises, causing frustration for both parties. The AI flags the call for human intervention due to escalating sentiment. A representative takes over the call, reviews the context provided by the AI, clarifies the terms, and finalizes the booking with the carrier, ensuring satisfaction and efficiency.

In another example scenario, there may be a pickup confirmation issue. In this example, the AI agent calls a carrier to confirm the pickup date and time for a scheduled load. The carrier expresses confusion, stating they were unaware of the booking. The AI flags the call for human intervention. A representative steps in, accesses detailed records through the dashboard, explains the situation to the carrier, and resolves the misunderstanding by scheduling a new pickup or rerouting the load as needed.

In another example scenario, there may be a takeover complex technical query. In this example, a customer asks highly specific questions that the AI cannot answer. The call is flagged, and a representative takes over. Using the integrated dashboard, the representative accesses relevant technical documents recommended by the system, ensuring a swift and accurate resolution.

In another example, there may be a dashboard navigation query. For example, a new user may ask the system, “How do I access the analytics dashboard?” The system can provide a guided tutorial, either through voice or an on-screen walkthrough, showing the user exactly where to find the feature and how to use it.

In another example, a manager may query, “What was the average profit margin last week?” In response, the system can generate a detailed report, complete with visual graphs and breakdowns, comparing it to the prior week's performance for context.

In another example, a team leader can ask the system to simulate a call resolution scenario based on historical data. In response, the system can use past metrics to predict outcomes and suggests strategies for optimizing future performance.

Offering customizable features within the dashboard, systems disclosed herein can cater to the unique needs of different industries or businesses. For example, logistics companies may prioritize shipment tracking insights, while financial services may focus on compliance reporting.

Regular updates to AI algorithms, user interfaces, and system functionalities of systems disclosed herein can ensure relevance and adaptability. Feedback loops and analytics can inform these updates to address emerging challenges and opportunities.

Periodic load testing and scenario simulations can ensure that the system performs well under varying conditions, particularly during high-traffic periods or unexpected events.

Ensuring that systems disclosed herein accommodate diverse user needs, including accessibility features like voice control, multilingual support, and compatibility with assistive technologies, broadens its usability and inclusivity. These additional considerations emphasize the importance of maintaining a dynamic and responsive approach to the system's deployment and evolution, aligning technical sophistication with practical usability.

Voice authentication, also known as voice biometrics, can be a functionality of systems disclosed herein for authenticating based an individual's unique vocal characteristics. Every person's voice has distinct features, including pitch, tone, rhythm, accent, and even the shape of their vocal tract. These characteristics are influenced by both physiological traits, such as vocal cord structure, and behavioral factors, like speech patterns. Because these attributes can be difficult to replicate, voice authentication is considered a reliable biometric tool for verifying identity. The technology creates a voiceprint—a digital representation of the speaker's voice—that is stored securely for future comparisons.

A foundation of voice authentication can involve signal processing and pattern recognition. Advanced algorithms analyze the intricate details of a speaker's voice, extracting unique identifiers and distinguishing them from others. Key parameters, such as frequency, amplitude, and temporal variations, are encoded in the voiceprint. Unlike traditional authentication methods like passwords or PINs, voice authentication eliminates the reliance on knowledge-based credentials, providing a more secure and user-friendly experience.

The technology's evolution has been fueled by rapid advancements in AI and machine learning (ML). AI-driven systems can use neural networks to process and analyze vast amounts of voice data, improving the accuracy and efficiency of voice authentication. These systems are designed to learn and adapt, enabling them to accommodate variations in a person's voice over time due to aging, illness, or environmental factors. ML models can enable real-time detection of anomalies, such as attempts to spoof the system with pre-recorded or synthesized voices.

An example advantage of voice authentication is its convenience. Unlike physical biometrics, such as fingerprints or facial recognition, voice-based systems do not require physical interaction with a device. This hands-free functionality makes them ideal for a wide range of applications, from unlocking smartphones to verifying identities in call centers. Additionally, voice authentication can be seamlessly integrated into devices and systems already equipped with microphones, such as smart speakers, telecommunication systems, and wearable devices. However, the adoption of voice authentication has raised significant privacy concerns. Voice data can be highly sensitive and, if misused or compromised, could lead to severe consequences, including identity theft. Unlike a password, a voiceprint cannot be easily replaced if stolen. To address these concerns, organizations implementing voice authentication systems can adopt robust security measures, such as encryption and strict access controls, and comply with privacy regulations to protect users' data.

Another challenge is the variability of voice. Factors such as illness, fatigue, stress, or even background noise can affect the accuracy of voice authentication systems. For instance, a person with a cold may sound significantly different from their usual voice, leading to authentication errors. Researchers and developers are working to overcome these limitations by designing systems that are more resilient to such variations. Techniques like adaptive voice modeling and noise-cancellation algorithms are increasingly being used to enhance reliability.

The emergence of synthetic voice technologies, such as deepfake audio, poses another significant challenge. These technologies can mimic a person's voice with alarming accuracy, potentially compromising voice authentication systems. To counter this threat, developers are incorporating anti-spoofing measures, such as liveness detection and contextual verification, into their systems. These techniques analyze factors like the natural flow of speech, breath sounds, and conversational coherence to distinguish genuine users from fraudulent attempts.

Despite these challenges, voice authentication continues to gain traction in industries like banking, healthcare, and telecommunications. Its potential to provide secure, convenient, and scalable identity verification solutions is driving innovation and adoption. As technology evolves, the focus will remain on balancing security, usability, and privacy to ensure voice authentication becomes a trusted cornerstone of biometric authentication systems in the future.

ML and deep learning (DL) techniques can be important for voice authentication systems, enabling precise and efficient analysis of complex vocal characteristics. These techniques process vast amounts of voice data to identify and verify unique features, such as pitch, tone, and rhythm. Traditional ML models like Gaussian Mixture Models (GMMs) and Support Vector Machines (SVMs) were initially employed in voice authentication to classify and compare voice patterns. These methods rely on handcrafted features extracted from audio signals, requiring significant domain expertise. While effective, these traditional approaches faced limitations in handling the complexities of natural voice variations and noisy environments.

The emergence of deep learning has transformed voice authentication, offering more robust and accurate solutions. Deep learning models, particularly deep neural networks (DNNs), excel at automatically learning features directly from raw audio data, bypassing the need for manual feature engineering. Convolutional Neural Networks (CNNs) and Recurrent Neural Networks (RNNs) are commonly used in voice authentication tasks. CNNs focus on capturing spatial patterns in voice spectrograms, while RNNs, especially their variants like Long Short-Term Memory (LSTM) networks, are adept at processing sequential data, making them ideal for analyzing temporal variations in speech.

One of the most significant breakthroughs in voice authentication is the use of speaker embedding techniques, such as x-vectors and i-vectors. These embeddings represent a speaker's unique vocal traits in a compact numerical format, facilitating efficient comparisons during authentication. Generated through deep learning models, these embeddings are highly discriminative and resilient to variations caused by background noise or voice changes over time. Furthermore, the integration of attention mechanisms into deep learning models has improved the system's ability to focus on relevant parts of the audio signal, enhancing accuracy and reliability.

In addition to enhancing accuracy, ML and DL techniques are pivotal in addressing security challenges, such as spoofing and synthetic voice attacks. Anti-spoofing measures leverage adversarial learning and advanced neural networks to detect anomalies indicative of fraudulent activity. For instance, Generative Adversarial Networks (GANs) are used to simulate and analyze potential attack scenarios, improving the robustness of voice authentication systems. As the capabilities of machine learning and deep learning continue to evolve, they remain indispensable tools for advancing voice authentication, ensuring a balance between security, usability, and resilience in a rapidly changing technological landscape.

Examples for authentication by use of systems disclosed herein include, but are not limited to, text-based authentication, formant analysis, pitch and frequency analysis, spectral analysis, template matching, dynamic time warping (DTW), cepstral analysis, harmonics-to-noise ratio (HNR), linear predictive coding (LPC), signal energy analysis, voice duration and tempo analysis, text-independent authentication, dynamic passphrases, biometric fusion, voice liveness detection, noise-robust authentication, deep neural networks, convolutional neural networks, recurrent neural networks and LSTMs, transformers, self-supervised learning, generative adversarial networks, zero-shot learning, speaker diarization, voice anti-spoofing models, federated learning for voice authentication, acoustic scene analysis with AI, phoneme-level analysis, and the like. Text-dependent authentication relies on traditional pattern-matching or signal-processing techniques to compare the user's spoken phrase to a stored recording. Formant analysis measures specific frequency bands (formants) in a person's voice that are influenced by the shape of their vocal tract. These patterns are compared to stored data for authentication. Pitch and frequency analysis uses statistical methods to analyze the pitch, frequency, and amplitude of a user's voice. It matches these characteristics against pre-recorded templates. Spectral analysis examines the spectral energy distribution of voice signals to identify unique voice patterns. This method typically involves signal processing rather than AI. Template matching compares a user's voice sample with a stored template using basic pattern recognition algorithms. It's straightforward but lacks adaptability to variations in speech. DTW matches the time-dependent aspects of speech, such as cadence and intonation, between a sample and a stored reference. It does not require AI but works well for fixed phrases. Cepstral analysis extracts cepstral coefficients (features derived from a signal's frequency spectrum) to analyze voice characteristics. Traditional statistical methods are used to compare these coefficients for authentication. HNR analyzes the ratio of harmonic components to noise in a voice signal to differentiate between individuals. This technique is based on basic acoustic analysis. LPC models the vocal tract using a mathematical approach to predict voice signal properties. LPC features are then compared with stored data for verification. Signal energy analysis uses the energy levels in voice signals to distinguish between users. It is a simple but less secure approach. Voice duration and tempo analysis evaluates the length of speech and rhythm to identify unique patterns. It is often used in conjunction with other non-AI methods. Text-independent authentication relies on machine learning to analyze complex vocal patterns and unique features like pitch, tone, and rhythm without needing specific phrases. Speaker embedding models use AI to create numerical embeddings of a user's voice, capturing unique characteristics for comparison. Dynamic passphrases enhanced with AI can analyze both the passphrase content and the voice's biometric features dynamically. Biometric fusion uses AI algorithms to integrate voice data with other biometric inputs, such as facial recognition, for multi-modal verification. Voice liveness detection employs AI to distinguish between live voices and playback attacks, analyzing speech patterns and contextual audio cues. Noise-robust authentication uses AI-powered noise cancellation and feature extraction techniques to ensure accurate authentication in noisy environments. Deep neural networks uses deep learning models to analyze complex voice features such as timbre, rhythm, and speech dynamics. DNNs can identify intricate patterns in a user's voice. Convolutional neural networks processes spectrograms (visual representations of sound) to extract unique features for voice authentication. CNNs are particularly effective for image-like input data. Recurrent neural networks and LSTMs are designed to handle sequential data like speech, these models analyze temporal patterns in voice signals, such as cadence and intonation. Transformers use advanced models like the Speech Transformers process entire speech sequences simultaneously, offering high efficiency and accuracy in capturing voice nuances. Self-supervised learning models learn voice characteristics from large, unlabeled datasets before fine-tuning on smaller labeled datasets for authentication, reducing the need for extensive labeled data. Generative adversarial networks can be used to improve the robustness of voice authentication by generating synthetic voice samples for training, helping systems detect spoofing attacks. Zero-shot learning enables authentication of new users with minimal enrollment data by leveraging pre-trained models to generalize voice patterns across individuals. Speaker diarization separates and identifies speakers in multi-speaker environments using AI models, which can also be adapted for authentication in dynamic scenarios. Voice anti-spoofing models involve AI systems specifically designed to detect and counter spoofing attacks like voice synthesis or replay attacks. These models analyze subtle inconsistencies in voice signals. Federated learning for voice enables decentralized model training on user devices to preserve privacy while enhancing the accuracy of voice biometrics authentication. Acoustic scene analysis with AI integrates contextual data such as background noise and environment to authenticate users more accurately and detect anomalies. Phoneme-level analysis uses AI models to analyze phonemes (distinct sound units in speech) for highly granular voice authentication. This improves precision, especially for multilingual users. Adaptive voice models can use AI systems that continuously learn and adapt to variations in a user's voice over time, such as changes due to aging or illness. Emotion-aware voice authentication can use AI to factor in emotional tones in voice signals, distinguishing between deliberate attempts at authentication and involuntary speech. Attention mechanism in AI models involve AI system to use attention layers to focus on the most critical voice features during analysis, improving both accuracy and efficiency.

In embodiments, system and computer-implemented methods disclosed herein use a two-factor authentication (2FA) technology to combine a dynamic passphrase and voice authentication for providing a secure and user-friendly method for verifying identity. This system leverages two complementary factors: a dynamically generated passphrase (“what you know”) and the unique biometric characteristics of a user's voice (“who you are”). Users are sent a random passphrase, which they must speak aloud, allowing the system to verify both the content of the passphrase and the authenticity of the voice.

In embodiments, the process can begin with generating and delivering a unique passphrase to the user via a secure channel. The user's spoken passphrase is recorded, processed into a spectrogram, and analyzed using two methods: speech-to-text to validate the passphrase and convolutional autoencoders (CAEs) to authenticate the voice. CAEs are trained individually for each user to learn their unique vocal patterns, making them resistant to impostors and emerging threats like deepfakes and voice cloning. This approach enhances security by requiring real-time, session-specific inputs and analyzing subtle voice nuances that are challenging to replicate.

Key advantages of this system include its ability to thwart replay attacks, mitigate risks posed by static credentials, and defend against voice spoofing technologies. It is particularly well-suited for high-risk applications in finance, logistics, and healthcare, where data protection and fraud prevention are critical. By combining advanced machine learning with intuitive usability, this 2FA system offers a robust, scalable, and future-proof solution for secure authentication.

A convolutional autoencoder (CAE) is a type of neural network that can be used for voice authentication by learning an efficient encoding of voice features. Using individual convolutional autoencoders (CAEs) for each person is a feasible approach for voice authentication. Each user gets their own CAE that is trained exclusively on their voice data. The goal is for the CAE to reconstruct its own user's voice spectrograms accurately but perform poorly on others. Below is an overview a convolutional autoencoder for voice authentication for use with systems and computer-implemented methods disclosed herein.

A CAE can include an encoder, a bottleneck layer (latent space), and a decoder. The encoder compresses the input data into a low-dimensional representation (latent space), extracting key features of the user's voice. The bottleneck layer can be the compressed representation of the voice. The bottleneck layer can act as a fingerprint of the user's voice, containing enough information to reconstruct the input spectrogram. The decoder can take the compressed representation and reconstructs the original spectrogram. The decoder can mirror the encoder, using convolutional transpose (or upsampling) layers.

In embodiments, the CAE can be trained by input of data, forward passing, loss calculation, backpropagation, and optimization. The input to the CAE can be the spectrogram of the user's voice. A spectrogram is a time-frequency representation of an audio signal, providing a visual way to analyze sound. The spectrogram can be passed through the encoder, bottleneck, and decoder to produce a reconstructed version of the input. The reconstruction loss (e.g., Mean Squared Error, MSE) can computed as the difference between the input spectrogram and the reconstructed

$$Loss = \frac{1}{N} {\sum }_{i = 1}^{N} {( {Original}_{i} - {Reconstructed}_{i} )}^{2}$$

spectrogram. An example loss formula follows:
Gradients can be calculated and propagated back through the network. Weights can be updated using an optimizer like Adam or RMSprop to improve reconstruction accuracy.

Phases of authentication by the CAE can include an enrollment phase, an authentication phase, and a threshold comparison phase. In the enrollment phase during training, the CAE learns to reconstruct only the enrolled user's voice spectrograms. In the authentication phase, a new voice sample is converted into a spectrogram and passed through the CAE. Reconstruction error can be calculated by low error (Indicates the voice belongs to the enrolled user) and high error (Suggests the voice does not match the user, as the CAE struggles to reconstruct unfamiliar patterns). For threshold comparison, a threshold can be set based on the reconstruction error distribution of the training data. If the error is below the threshold, the system authenticates the user; otherwise, authentication is denied.

For encoding, an input spectrogram X can be passed through convolutional layers to extract

$$Z = {f}_{Encoder} ( X ; {θ}_{Encoder} )$$

features:
where X is the reconstructed spectrogram, and O_{Decoder} are the weights of the decoder.

For decoding, the bottleneck representation Z is passed through the decoder to reconstruct

$$\hat{X} = {f}_{Decoder} ( Z ; {θ}_{Decoder} )$$

the spectrogram:
where X is the reconstructed spectrogram, and O_{Encoder} are the weights of the decoder.

For loss function, the loss function minimizes the difference between X and X″hat″:

$$ℒ = {‖ X - \hat{X} ‖}^{2}$$

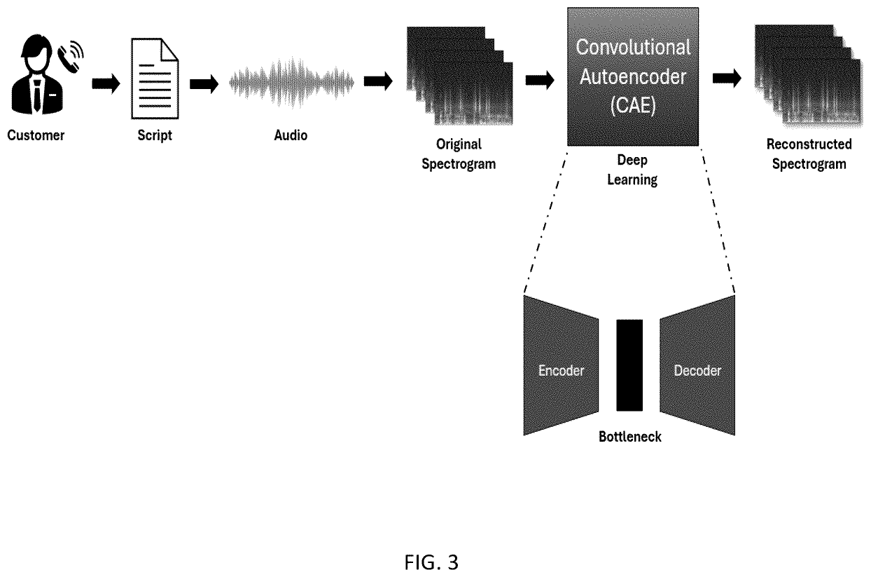

FIG. 3 illustrates a diagram depicting a voice authentication pipeline using convolutional autoencoders in accordance with embodiments of the present disclosure.

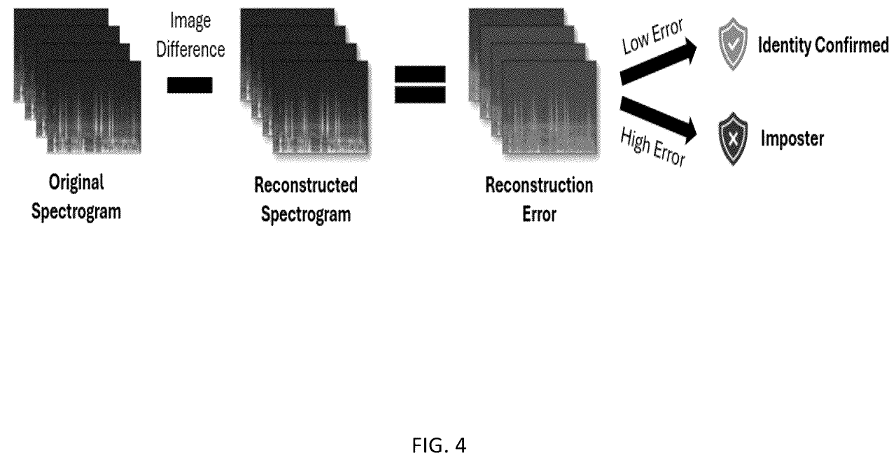

FIG. 4 illustrates a diagram depicting spectrogram error for voice authentication in accordance with embodiments of the present disclosure.

It is noted that voice data must be processed carefully to transform raw audio signals into a format suitable for use in a CAE. This process involves several steps, including preprocessing, feature extraction, and preparation for model training. Below is a detailed explanation of each step.

In accordance with embodiments, systems and computer-implement methods disclosed herein can involve data collection, which includes recording voice samples. Data collection can include collecting voice samples in common formats (e.g., WAV, MP3, FLAC); and use a fixed script to maintain consistency across samples, such as predefined phrases. All recordings can be resampled to a fixed sampling rate, such as, 16 kHz for common for speech processing; and 8 kHz for telephony-grade audio. This can ensure uniformity across all data. For mono conversion, audio can be converted to mono (single channel) if it is stereo, as most speech features are adequately captured in mono. The system can remove background noise to ensure clean audio input. The system can implement voice activity detection (VAD) to remove silent or non-speech segments to focus on the relevant parts of the audio signal.

For feature extraction, CAE models may require structured input like spectrograms rather than raw waveforms. Example transformations can include transformations such as short-time Fourier transform (STFT), which can covert the audio signal into a spectrogram, a 2D representation of frequency over time. A Mel spectrogram can project the spectrogram onto the Mel scale, which better aligns with human auditory perception. An MFCCs (Mel-Frequency Cepstral Coefficients) use can compress the Mel spectrogram into compact features commonly used in speech processing. For normalization, the extracted features can be normalized to scale values between 0 and 1, ensuring consistent input for the CAE. For padding, the system can pad or truncate features to a fixed size (e.g., 128×128) to ensure uniform input dimensions for the CAE.

For data augmentation, this can be used to improve model robustness by simulating real-world variations in voice data. Gaussian noise can be injected to simulate background environments. Time stretching can be used to speed up or slow down the audio without changing the pitch. Further, pitching shifting can be used to shift the pitch up or down to account for tonal variations.

In embodiments, data may be structured for use by CAE. For data shaping, preprocessed spectrograms may be shaped into 3D tensors of shape (e.g., samples, height, width, channels). Samples may be a number of audio samples. Height may be a number of frequency bins. Width may be a number of time steps. Channels may be a number of audio channels (1 for mono for example). For train/test split, the dataset may be split into training and validation/test sets (e.g., 80/20). The system may use batches of spectrograms for training the CAE.

For input to the CAE, the final processed voice data may be fed into the CAE as input tensors. The CAE can process this data to learn the unique features of the user's voice.

In embodiments, two-factor authentication (2FA) may be implemented. Traditional methods of authentication such as passwords or PINs are increasingly vulnerable to breaches and unauthorized access. To address these challenges, voice-based 2FA offers a highly secure and user-friendly solution by combining the verification of a dynamic passphrase with unique voice biometrics. This innovative system enhances security by requiring users to first receive a generated passphrase and then speak it aloud, ensuring that both the knowledge of the passphrase and the physical trait of the user's voice are verified. By leveraging both “what you know” and “who you are” factors, this method not only secures access but also provides a seamless authentication experience tailored to real-time environments.

The integration of passphrase verification and voice recognition introduces a robust layer of security, making it particularly suitable for high-risk applications in finance, healthcare, and logistics. The generated passphrase serves as a dynamic authentication factor that changes with each session, effectively mitigating the risks posed by static credentials. Advances in speech processing and machine learning enable the system to validate the spoken passphrase through speech-to-text technology and authenticate the user's voice using convolutional autoencoders. This comprehensive approach ensures that sensitive systems and data remain protected from unauthorized access.

Furthermore, this dynamic combination of passphrase and voice biometrics provides an effective defense against modern threats like deepfakes and voice cloning. Unlike traditional voice authentication systems that rely solely on matching static voice patterns, this approach dynamically generates a unique passphrase for each session, which the user must speak aloud. This ensures that even if an attacker has access to a cloned voice or a deepfake audio sample, they cannot replicate the required passphrase in real-time. Additionally, convolutional autoencoders analyze the subtle nuances of the user's voice, such as tone variations, speech cadence, and frequency patterns, which are difficult to replicate convincingly. Together, these measures create a highly secure system resilient to increasingly sophisticated voice spoofing technologies.

As an overview of authentication, systems and computer-implemented methods disclosed herein can generate a unique passphrase and sends it to the user (e.g., via text, app, or email). This can be a first factor. As a second factor, the user may speak the passphrase. For passphrase verification, the system can determine whether the spoken phrase matches the generated passphrase. For voice authentication, the system can verify whether the voice matches using the user's trained CAE model.

For implementation of authentication, systems and computer-implemented methods disclosed herein can generate a random, human-readable passphrase for each authentication session. In an example, a passphrase can be generated and delivered to the user (e.g., “Secure Falcon 392” or “Green Maple 87”). The passphrase can be delivered to the user securely (e.g., via SMS using APIs like Twilio, via email using Python's smtplib, or via mobile app that integrates with a notification system, such a Firebase). Subsequently, the user can speak the passphrase. For example, the user can be prompted to speak the passphrase aloud. Audio input of the spoken passphrase can be captured. For example, a microphone or device API can be used to record the user's speech. The recording can be saved as a WAV file or other suitable audio file. The recorded audio can subsequently be preprocessed. For example, the spoken audio can be converted into a spectrogram using the same preprocessing pipeline used to train the CAE. The text may be extracted using speech-to-text for passphrase verification. Voice authentication can be implemented by: converting the recorded audio into a spectrogram; passing the spectrogram through the CAE trained on the user's voice to compute the reconstruction error; and authenticating the user if the passphrase matches and the reconstruction error is below the authentication threshold.

In embodiments, each CAE can be trained on a single user's voice data, capturing the unique characteristics of that person's voice, such as pitch, tone, accent, and speaking style. This personalized approach reduces the risk of false positives (accepting another user's voice) and increases the accuracy of authentication. For High-Security Applications such as with systems like online banking or access to secure facilities, the unique characteristics captured by a user-specific CAE ensure that only the intended user is authenticated. Custom thresholds may be used for users with distinct voice patterns (e.g., regional accents or speech impairments), the personalized model reduces the chances of false rejection or false acceptance.

For enhanced anomaly detection, individual CAEs may be optimized to reconstruct their user's voice spectrograms with minimal error. When an impostor's voice is passed through the model, the reconstruction error is significantly higher because the model hasn't seen this voice pattern before. This can make the reconstruction error a reliable indicator for distinguishing between genuine users and impostors. In scenarios where impostors may try to gain access (e.g., shared devices or public kiosks), the CAE's high reconstruction error for unauthorized users provides robust protection. CAEs trained on genuine voice data are less likely to reconstruct replayed audio or synthesized voices accurately, making it harder for attackers to spoof.

In embodiments, scalability may be provided across users. A system may add a new user involves training a separate CAE for that user without affecting the performance of existing models. There may be no need to retrain or fine-tune a global model whenever a new user is added. Systems with growing user bases (e.g., a multi-user voice assistant) can add new users without needing to retrain a global model, allowing for rapid deployment. Each user's CAE can run locally on their device, such as smartphones or IoT gadgets, without dependence on a central server.

Since each CAE is tailored to one user's voice, it becomes extremely difficult for an impostor to replicate the exact features the model has learned. Even if the impostor mimics the user's voice, the subtle variations in frequency and spectrogram patterns will lead to a high reconstruction error.

For enterprise access control, in corporate environments where voice authentication is used for employee access, individual CAEs reduce the risk of coworkers impersonating one another. For customer support verification, when customers verify their identity via voice over a call, the model's ability to distinguish between genuine and impostor voices ensures better security. Each user can have their own reconstruction error threshold based on their voice data. This allows for fine-tuned security levels per user, accommodating natural variations in speaking style or recording environments. As an example for high-security users, such as executives, can have stricter thresholds, while general users can have more lenient settings to balance convenience and security. For adaptive authentication, thresholds can adapt to user-specific patterns over time, making the system more flexible and reducing false rejection rates.

Systems and computer-implemented methods disclosed herein can provide flexibility in model updates. If a user's voice characteristics change over time (e.g., due to aging, illness, or other factors), only their CAE needs retraining, leaving other users' models unaffected. Users can also re-enroll by providing fresh samples to retrain their individual CAE. For users whose voices may change due to aging, medical conditions, or environmental factors, retraining their individual CAE ensures continued accurate authentication. In customer-facing applications (e.g., call centers), users can re-enroll by simply providing new voice samples, making the system resilient to user updates.

Since each CAE is user-specific, there's no central model containing shared embeddings or voice features of multiple users. This decentralized structure reduces the risk of data leakage or unauthorized access to voice features from other users. In privacy-sensitive environments, such as personal devices or medical records, CAEs can operate locally, ensuring that users' voice data doesn't need to be uploaded to a central server. Systems can meet data protection regulations (e.g., GDPR or CCPA) by minimizing data sharing between users or across systems.

Each CAE operates independently, enabling a modular system where users' CAEs can run on separate devices or servers. This allows for distributed processing, reducing bottlenecks and making the system more resilient to single points of failure. In large-scale deployments (e.g., smart city infrastructure), individual CAEs can be deployed on edge devices, ensuring real-time authentication without overloading central servers. If one module (CAE) fails or becomes inaccessible, it does not affect the operation of other users' models, improving overall system resilience.

New data for a specific user can be incrementally added to their CAE without requiring access to or retraining of other users' models. This is particularly useful in dynamic environments where users may periodically update their enrolled voice samples. In systems that allow ongoing training, such as personalized voice assistants, users can add new samples periodically to improve the accuracy of their CAE without affecting others. Updates to a user's CAE do not require downtime or interference with other users, ensuring smooth system operation.

In embodiments, systems and computer-implemented methods disclosed herein can provide resistance to dataset bias. A single-user CAE is only exposed to the voice features of that user during training, avoiding biases introduced by other users' data. This ensures that the model is not influenced by characteristics irrelevant to the target user. For systems used across diverse populations (e.g., international customer support platforms), user-specific CAEs avoid biases introduced by other users' accents or speaking styles. In environments where users have unique needs (e.g., children, elderly users, or those with speech impairments), CAEs remain unbiased, as they only learn from their owner's data.

In an example scenario for voice biometric banking, each customer's voice can be authenticated using their unique CAE. This ensures that even if an attacker gains access to one CAE, it won't compromise other accounts. In smart home device applications, personalized voice authentication for family members ensures that only authorized users can access sensitive controls or information (e.g., unlocking a smart lock or accessing payment details). In healthcare applications, patients can use voice authentication for accessing telemedicine services. Individual CAEs provide enhanced security while ensuring personalized recognition. In call center authentication applications, CAEs can help call centers verify customers' voices during interactions, reducing reliance on PINs or passwords.

In the logistics industry, motor carriers are assigned an MC number by the Federal Motor Carrier Safety Administration (FMCSA). This unique number is essential for identifying carriers in freight brokerage, load assignments, and compliance processes. Using individual convolutional autoencoders (CAEs) for voice authentication can enhance the security of MC number verification, ensuring that only authorized carriers can access or use this credential.

In an application for securing MC number usage for load assignments, freight brokers often work with multiple motor carriers and use their MC numbers to verify identity during load assignments and compliance checks. Fraudulent use of MC numbers by unauthorized parties can result in financial losses, shipment theft, and legal issues. MC numbers alone may be insufficient for secure authentication as they can be easily shared or stolen. Voice authentication tied to individual MC numbers can ensure that only the authorized carrier associated with a given MC number can verify their identity.

In an enrollment phase during onboarding, each carrier can provide their MC number along with a set of voice samples. Voice samples include predefined phrases like: “My MC number is [number]” and “I am confirming my load assignment”. A CAE can be trained on their voice spectrograms to associate their voice with their MC number. When a carrier contacts a broker to claim or confirm a load, they provide their MC number and a voice command. The system verifies the MC number and authenticates the voice using the associated CAE. If the voice matches the stored CAE for that MC number, the carrier is authorized to access shipment details. During regulatory or compliance interactions, carriers use voice authentication to verify their identity alongside their MC number, adding a biometric layer to ensure authenticity. Carriers calling to report shipment status or request changes are authenticated using their MC number and voice. Before processing payments, brokers authenticate the carrier's MC number and voice to confirm delivery completion.

For motor carrier operations, voice authentication can ensure that even if an MC number is stolen or shared, unauthorized parties cannot use it without the matching voice authentication. Further, it protects against fraud and impersonation during load assignments. Every load assignment, shipment update, and payment process is tied to an authenticated voice and MC number, creating a clear audit trail for disputes and compliance. Authentication using voice and MC numbers is faster than manual identity checks, reducing delays during load assignments and communications. New carriers can be added by training a CAE for their voice and associating it with their MC number, without disrupting existing operations. This eliminates unauthorized use of MC numbers, protecting brokers, shippers, and legitimate carriers from financial and reputational losses. Carriers access digital load boards by providing their MC number and authenticating via voice. Only authorized carriers can claim loads under a given MC number. Brokers verify the identity of carriers calling in with an MC number by matching their voice to the CAE associated with that number. Before releasing payments for completed shipments, brokers authenticate carriers to ensure payments are made to the rightful entities. During audits or regulatory checks, carriers can authenticate themselves using their voice and MC number, simplifying verification for brokers and authorities.

In examples, multiple CAEs can be trained for different individuals authorized under the same MC number, allowing for team-based authentication. For noisy environment, the system can preprocess audio to reduce noise and train CAEs on augmented voice data to handle real-world conditions. For some examples, the system can start with high-value carriers and gradually onboard additional carriers, focusing on those handling sensitive or high-value shipments.

In examples, carriers are registered with their MC number and voice samples. Each carrier's CAE is trained to recognize their voice in association with their MC number. In an example, a carrier can call the broker: “My MC number is 123456. I'm confirming the pickup for load 7890.” The broker's system can: (1) verify the MC number; (2) match the voice command to the CAE for that MC number; and (3) grant access to shipment details if authenticated. For shipment update, the carrier can say “This is MC 123456. The load has been delivered.”; and the system can ensure the carrier is authorized before releasing payment. For brokers, enhanced security prevents unauthorized use of MC numbers. For accountability, every interaction is tied to an authenticated individual, reducing disputes. For carriers, they feel secure knowing their MC numbers are protected. This can simplify regulatory interactions with voice-based authentication. For the logistics industry, it established a higher standard of security and trust in carrier identity verification. It can reduce fraud, theft, and operational inefficiencies.

There are various considerations for implementing and refining the 2FA system combining passphrase and voice recognition. It should be ensured that passphrases are truly random and human-readable to prevent predictability and improve usability. Timestamps or session identifiers can be used to ensure each passphrase is valid only once, preventing attackers from reusing previous audio. For added security, integrate the system with other biometrics (e.g., facial recognition) in high-security environments.

For multi-layer biometrics, real-time processing can optimize the speech-to-text and voice authentication models to process data in real-time, ensuring a seamless user experience. The system can securely store user data, ensuring compliance with privacy regulations like GDPR, HIPAA, or CCPA. Use encryption for voice data and passphrase logs. In noisy environments, the system can use advanced noise reduction algorithms to preprocess audio input; and train models on augmented datasets with background noise to improve robustness. The system can regularly update user profiles to account for changes in voice due to aging, illness, or emotional state. For speech-to-text accuracy, the system can fine-tune the speech recognition engine for common passphrase vocabulary; and implement error-tolerant matching to handle slight variations in spoken phrases.

For usability, user-friendly passphrases can ensure passphrases are short, easy to pronounce, and culturally neutral to accommodate diverse user bases. Further, words can be avoided that are easily misheard or ambiguous in noisy conditions. Multi-language support can be provided for passphrases and speech recognition to cater to global users.

For onboarding, the system can provide clear instructions during registration and authentication to guide users through the process. The system can be based on a scalable architecture that uses cloud-based or distributed systems to handle large-scale deployments, such as in banking or logistics; and implements load balancing to manage high authentication request volumes. For edge processing in latency-sensitive applications, edge computing can be used to process audio locally and minimize server dependency.

For fraud detection, the system can implement anomaly detection to flag suspicious behavior, such as repeated failed attempts or mismatched passphrases and voices. The system can log authentication attempts and outcomes for forensic analysis and compliance reporting. The system can conduct usability tests to refine the system based on user experiences and feedback. The system can evaluate key metrics such as False Acceptance Rate (FAR), False Rejection Rate (FRR), Equal Error Rate (EER), and response time. The system can test against simulated attacks, including deepfakes, voice cloning, and replay attacks, to identify and address vulnerabilities.

The functional units described in this specification have been labeled as computing devices. A computing device may be implemented in programmable hardware devices such as processors, digital signal processors, central processing units, field programmable gate arrays, programmable array logic, programmable logic devices, cloud processing systems, or the like. The computing devices may also be implemented in software for execution by various types of processors. An identified device may include executable code and may, for instance, comprise one or more physical or logical blocks of computer instructions, which may, for instance, be organized as an object, procedure, function, or other construct. Nevertheless, the executable of an identified device need not be physically located together but may comprise disparate instructions stored in different locations which, when joined logically together, comprise the computing device and achieve the stated purpose of the computing device. In another example, a computing device may be a server or other computer located within a retail environment and communicatively connected to other computing devices (e.g., POS equipment or computers) for managing accounting, purchase transactions, and other processes within the retail environment. In another example, a computing device may be a mobile computing device such as, for example, but not limited to, a smart phone, a cell phone, a pager, a personal digital assistant (PDA), a mobile computer with a smart phone client, or the like. In another example, a computing device may be any type of wearable computer, such as a computer with a head-mounted display (HMD), or a smart watch or some other wearable smart device. Some of the computer sensing may be part of the fabric of the clothes the user is wearing. A computing device can also include any type of conventional computer, for example, a laptop computer or a tablet computer. A typical mobile computing device is a wireless data access-enabled device (e.g., an iPHONE® smart phone, an iPAD® device, smart watch, or the like) that is capable of sending and receiving data in a wireless manner using protocols like the Internet Protocol, or IP, and the wireless application protocol, or WAP. This allows users to access information via wireless devices, such as smart watches, smart phones, mobile phones, pagers, two-way radios, communicators, and the like. Wireless data access is supported by many wireless networks, including, but not limited to, Bluetooth, Near Field Communication, CDPD, CDMA, GSM, PDC, PHS, TDMA, FLEX, ReFLEX, iDEN, TETRA, DECT, DataTAC, Mobitex, EDGE and other 2G, 3G, 4G, 5G, and LTE technologies, and it operates with many handheld device operating systems, such as EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone or smart watch that operates over GPRS (General Packet Radio Services), which is a data technology for GSM networks or operates over Near Field Communication e.g. Bluetooth. In addition to a conventional voice communication, a given mobile device can communicate with another such device via many different types of message transfer techniques, including Bluetooth, Near Field Communication, SMS (short message service), enhanced SMS (EMS), multi-media message (MMS), email WAP, paging, or other known or later-developed wireless data formats. Although many of the examples provided herein are implemented on smart phones, the examples may similarly be implemented on any suitable computing device, such as a computer.

An executable code of a computing device may be a single instruction, or many instructions, and may even be distributed over several different code segments, among different applications, and across several memory devices. Similarly, operational data may be identified and illustrated herein within the computing device, and may be embodied in any suitable form and organized within any suitable type of data structure. The operational data may be collected as a single data set, or may be distributed over different locations including over different storage devices, and may exist, at least partially, as electronic signals on a system or network.

The described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

As used herein, the term “memory” is generally a storage device of a computing device. Examples include, but are not limited to, read-only memory (ROM) and random access memory (RAM).

The device or system for performing one or more operations on a memory of a computing device may be a software, hardware, firmware, or combination of these. The device or the system is further intended to include or otherwise cover all software or computer programs capable of performing the various heretofore-disclosed determinations, calculations, or the like for the disclosed purposes. For example, exemplary embodiments are intended to cover all software or computer programs capable of enabling processors to implement the disclosed processes. Exemplary embodiments are also intended to cover any and all currently known, related art or later developed non-transitory recording or storage mediums (such as a CD-ROM, DVD-ROM, hard drive, RAM, ROM, floppy disc, magnetic tape cassette, etc.) that record or store such software or computer programs. Exemplary embodiments are further intended to cover such software, computer programs, systems and/or processes provided through any other currently known, related art, or later developed medium (such as transitory mediums, carrier waves, etc.), usable for implementing the exemplary operations disclosed below.

In accordance with the exemplary embodiments, the disclosed computer programs can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl, or other suitable programming languages.

As referred to herein, the terms “computing device” and “entities” should be broadly construed and should be understood to be interchangeable. They may include any type of computing device, for example, a server, a desktop computer, a laptop computer, a smart phone, a cell phone, a pager, a personal digital assistant (PDA, e.g., with GPRS NIC), a mobile computer with a smartphone client, or the like.

As referred to herein, a user interface is generally a system by which users interact with a computing device. A user interface can include an input for allowing users to manipulate a computing device, and can include an output for allowing the system to present information and/or data, indicate the effects of the user's manipulation, etc. An example of a user interface on a computing device (e.g., a mobile device) includes a graphical user interface (GUI) that allows users to interact with programs in more ways than typing. A GUI typically can offer display objects, and visual indicators, as opposed to text-based interfaces, typed command labels or text navigation to represent information and actions available to a user. For example, an interface can be a display window or display object, which is selectable by a user of a mobile device for interaction. A user interface can include an input for allowing users to manipulate a computing device, and can include an output for allowing the computing device to present information and/or data, indicate the effects of the user's manipulation, etc. An example of a user interface on a computing device includes a GUI that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. The display object can be displayed on a display screen of a computing device and can be selected by and interacted with by a user using the user interface. In an example, the display of the computing device can be a touch screen, which can display the display icon. The user can depress the area of the display screen where the display icon is displayed for selecting the display icon. In another example, the user can use any other suitable user interface of a computing device, such as a keypad, to select the display icon or display object. For example, the user can use a track ball or arrow keys for moving a cursor to highlight and select the display object.

The display object can be displayed on a display screen of a mobile device and can be selected by and interacted with by a user using the interface. In an example, the display of the mobile device can be a touch screen, which can display the display icon. The user can depress the area of the display screen at which the display icon is displayed for selecting the display icon. In another example, the user can use any other suitable interface of a mobile device, such as a keypad, to select the display icon or display object. For example, the user can use a track ball or times program instructions thereon for causing a processor to carry out aspects of the present disclosure.

As referred to herein, a computer network may be any group of computing systems, devices, or equipment that are linked together. Examples include, but are not limited to, local area networks (LANs) and wide area networks (WANs). A network may be categorized based on its design model, topology, or architecture. In an example, a network may be characterized as having a hierarchical internetworking model, which divides the network into three layers: access layer, distribution layer, and core layer. The access layer focuses on connecting client nodes, such as workstations to the network. The distribution layer manages routing, filtering, and quality-of-server (QoS) policies. The core layer can provide high-speed, highly-redundant forwarding services to move packets between distribution layer devices in different regions of the network. The core layer typically includes multiple routers and switches.

The present subject matter may be a system, a method, and/or a computer program product. The computer program product may include a computer readable storage medium (or media) having computer readable program instructions thereon for causing a processor to carry out aspects of the present subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a RAM, a ROM, an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network, or Near Field Communication. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++, Javascript or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present subject matter.

Aspects of the present subject matter are described herein with reference to flowchart illustrations and/or block diagrams of methods, apparatus (systems), and computer program products according to embodiments of the subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the embodiments have been described in connection with the various embodiments of the various figures, it is to be understood that other similar embodiments may be used, or modifications and additions may be made to the described embodiment for performing the same function without deviating therefrom. Therefore, the disclosed embodiments should not be limited to any single embodiment, but rather should be construed in breadth and scope in accordance with the appended claims.

1. A system comprising:
a communication session manager configured to:
define a supervising human agent;
identify a plurality of virtual entity communication sessions assigned to the supervising human agent, thus defining a plurality of monitored virtual entity communication sessions;
render a user interface that presents the plurality of monitored virtual entity communication sessions;
receive selection, by the supervising human agent, of one of the plurality of monitored virtual entity communication sessions, thus defining a selected virtual entity communication session; and
involve the supervising human agent in the selected virtual entity communication session.

2. The system of claim 1, wherein the communication session manager is configured to enable the supervising human agent to take over the selected virtual entity communication sessions from a virtual entity.

3. The system of claim 1 wherein the communication session manager is configured to enable the supervising human agent to join the selected virtual entity communication sessions with a virtual entity.

4. The system of claim 1, wherein the communication session manager is configured to render a detail view for the selected virtual entity communication session.

5. The system of claim 1, wherein the selected virtual entity communication session includes:
a voice-based virtual entity communication session;
an SMS-based virtual entity communication session;
a chat-based virtual entity communication session; and/or
an email-based virtual entity communication session.

6. The system of claim 1, wherein the communication session manager is configured to color code one or more of the plurality of monitored virtual entity communication sessions illustrated within the user interface.

7. The system of claim 1, wherein the communication session manager is configured to sequence the plurality of monitored virtual entity communication sessions illustrated within the user interface.

8. The system of claim 1, wherein at least one participant of the selected virtual entity communication session is a virtual entity.

9. The system of claim 8, wherein the virtual entity includes:
a virtual agent; and/or
a virtual avatar.

10. The system of claim 9, wherein the virtual avatar is based, at least in part upon the virtual agent, an avatar visual component and an avatar audio component.

11. A method comprising:
defining a supervising human agent;
identifying a plurality of virtual entity communication sessions assigned to the supervising human agent, thus defining a plurality of monitored virtual entity communication sessions;
rendering a user interface that presents the plurality of monitored virtual entity communication sessions;
receiving selection, by the supervising human agent, of one of the plurality of monitored virtual entity communication sessions, thus defining a selected virtual entity communication session; and
involving the supervising human agent in the selected virtual entity communication session.

12. The method of claim 11, further comprising enabling the supervising human agent to take over the selected virtual entity communication sessions from a virtual entity.

13. The method of claim 11, further comprising enabling the supervising human agent to join the selected virtual entity communication sessions with a virtual entity.

14. The method of claim 11, further comprising rendering a detail view for the selected virtual entity communication session.

15. The method of claim 11, wherein the selected virtual entity communication session includes:
a voice-based virtual entity communication session;
an SMS-based virtual entity communication session;
a chat-based virtual entity communication session; and/or
an email-based virtual entity communication session.

16. The method of claim 11, further comprising color coding one or more of the plurality of monitored virtual entity communication sessions illustrated within the user interface.

17. The method of claim 11, sequencing the plurality of monitored virtual entity communication sessions illustrated within the user interface.

18. The system of claim 11, wherein at least one participant of the selected virtual entity communication session is a virtual entity.

19. The method of claim 18, wherein the virtual entity includes:
a virtual agent; and/or
a virtual avatar.

20. The method of claim 19, wherein the virtual avatar is based, at least in part upon the virtual agent, an avatar visual component and an avatar audio component.
